(19) United States
(12) Patent Application Publication
(10) Pub. No.: US 2008/0071833 A1
(43) Pub. Date: Mar. 20, 2008

(54) Sporting event planning and management system

(75) Inventor: Gregory Alan Madden, Lakeland, FL (US)

Correspondence Address: AKERMAN SENTERFITT, P.O. BOX 3188, WEST PALM BEACH, FL, 33402-3188, US

(73) Assignee: TournEase, Inc., Lakeland, FL (US)

(21) Appl. No.: 11/732,638

(22) Filed: Apr. 4, 2007

Related U.S. Application Data
(60) Provisional application No. 60/825,824, filed on Sep. 15, 2006.

(51) Int. Cl. G06F 17/00

(52) U.S. Cl. 707/104.1; 707/E17.005

(57) ABSTRACT

An event planning and management system comprising a system module for storing event data comprising sponsor information, logo information, marketing information, products information, venue information, participant information, current event information, and past event information. The system further comprising a plurality of service management modules using event data to provide services associated with types of information in the event data. The system further comprising an event planning module and an event management module, both being linked with the plurality of service management modules to monitor and adjust services associated with the current event plan.

### CROSS-REFERENCE TO RELATED APPLICATIONS

This application claims priority to U.S. Provisional Application Ser. No. 60/825,824, filed Sep. 15, 2006, the entire contents of which are incorporated herein by reference.

### FIELD OF THE INVENTION

The present invention relates generally to event planning and management, and more particularly to a system for event planning and management that allows integrated planning and management of a sponsored event.

### BACKGROUND OF THE INVENTION

Non-profit organizations, community groups, and corporations organize a large number of funding raising events, such as banquets, concerts, and sporting events. More often than not, these organizations repeat the activity on an annual basis. As a result, these event organizers are generally required to interact with a large number of parties, on an annual basis, in order to provide a wide variety of goods and services. These parties generally comprise a large group, including venue operators, event sponsors, concessionaires and caterers, event-related products vendors, and numerous participants.

Generally, the event organizers delegate the planning of the event to volunteers within the organization. Because the volunteers generally change every year, the volunteers planning the current event generally expend much time in attempting to reconstruct how past groups of volunteers organized and executed the event. Generally recordkeeping of such past events is poor. Other times files may be available from year to year, but such files are incomplete. In the rare case when such files are available and complete, they are often kept only in paper form with no means to automate year after year. Therefore, even when all files are available, the event organizer must still re-execute each and every aspect of the event, which can be further complicated when the venue must be altered.

Notwithstanding the lack of an available means to repeat such events, there is also a lack of available means to plan the event to be repeated. It is generally known in the art that for events such as banquets and parties, an event organizer traditionally turns to a professional consulting service to plan the event. However, in the case of specialized events, it can be extremely difficult to find a professional service capable of handling the planning of a complex event. For example, the golf tournament planning field is a very fragmented industry that has not used technology to gain productivity or repeatability. Other similarly complex events, such as tennis tournaments, fairs, or any other event in which the number of parties involved in planning and execution is large presents similar difficulties, face similar issues.

First, event planning services are generally provided in the form of consulting services or database driven applications, which may be licensed for a fee. In the case of consulting services, the number of events the service provider can support is generally limited and therefore desired service providers are not always readily available to the event organizer. Additionally, such service providers do not generally handle marketing, advertising, or other related services. As a result, the event organizer must seek additional consulting services in order to receive additional services such as preparation and distribution of advertising and marketing materials or preparation and execution of computer or internet-based applications and materials. Furthermore, such service providers have generally not used technology to automate repeated planning of events. Therefore, it becomes difficult to find consultants who can handle all the issues involved in planning a golf tournament or similar event.

Similarly, in the case of licensed database applications, the license generally includes use and limited support, but do not make any other type of goods or services available. Additionally, such applications are generally limited to storage of files and information. Furthermore, such applications are generally designed for the venue operator or a provider of goods and services, not the event organizer. In the case of golf event planning, such applications are typically available only to the golf course operator and are limited in scope to the services available at the golf course.

Second, offerings in sporting event-related products and services available to the event organizer are generally limited. Event organizers are generally required to plan for all the goods and services purchased during the execution of a tournament. These may include apparel, participant gifts and awards, contest prizes, insurance coverage, signs, and banners. Typically, event organizers must rely on the venue operator to provide such goods and services, which are often limited in scope and selection. In the case of a golf tournament, the products and goods may be limited to only those available through the pro shop at the golf course. As a result, the event planning is further complicated, as the event organizer may have to seek out one or more third parties to provide any customized products and services not available from the venue operator.

Third, although consulting services generally exist to assist event organizers in seeking sponsors, services and systems available to manage sponsors are limited. Additionally as the number of sponsors increases, management of sponsors can become unwieldy. Generally, a sponsor will provide sponsorship for specific or multiple aspects of the sporting event. Many times such aspects may not be unique, may occur concurrently, and may vary in length of time. In a golf tournament, for example, several sponsors may provide sponsorship for a specific and separate golf holes on the same day. This requires the event organizer to manage a large amount of sponsors, participants, and other services over a short period of time and can result in confusion and misidentification of sponsorship during advertising, marketing, planning, or execution of the event.

Similarly, management of approved logos and marks of sponsors can be difficult, especially as the number of sponsors increase. Use of logos typically requires approval by the sponsor and updating year after year. Additionally, event organizers must generally keep track of use several logos for each sponsor that are only acceptable for certain types of duplication and enlargement. In the case of a golf tournament, for example, a single sponsor's logo may appear in an advertisement, a hole sign, and a banner, each point of use requiring use of a different sized logo. At a large event, when dealing with multiple sponsors, multiple logos, and multiple points of advertising and marketing, the result again can be confusion and misuse of logos and sponsorship.

Fourth, once the sponsored event is planned and executed, there is no means for event organizers to efficiently monitor the event as it progresses. With no centralized system to monitor the event, the event organizer may lose track of vendors, participants, goods, or more importantly, revenues and expenses. For example, in a golf event, participants may arrive late or not arrive at all, requiring the event organizer to redistribute participants and services, or even cancel services. Additionally, without a centralized system to monitor the event, it may become difficult for event organizers to react quickly to unexpected events occurring during the event.

Therefore, there is a need for a comprehensive sponsored event planning and execution solution that integrates all services required such as event planning and event execution. There is a need that such a solution includes a centralized system for managing advertising, marketing, and finances. In addition, there is a need that such a solution includes access to a comprehensive offering of related goods and services. Furthermore, such a solution requires a simplified and centralized system for managing sponsors and for managing advertising and marketing utilizing their logos. Furthermore, there is a need for such a solution to provide the technology to plan, execute, and repeat planning of the same or a similar sporting event at the same or different venue.

### SUMMARY OF THE INVENTION

The present invention uses an event planning and management system that integrates the various aspect of sponsored event planning and management, and interrelates information obtained from multiple modules associated with the various aspects of sponsored event planning and management.

In accordance with an aspect of the invention, there is provided an event planning and management system that can comprise: a system module for storing event data comprising sponsor information, marketing information, venue information, and current event information; a sponsor management module using the sponsor information to provide sponsor services; a marketing management module using the marketing information to provide marketing services; a venue management module using the venue information to provide venue services; an event planning module for creating a current event plan using the event data, with the event planning module being linked with the sponsor management module, the marketing management module, and the venue management module to provide the sponsor services, the marketing services, and the venue services associated with the current event plan; and an event management module for managing execution of the current event plan using the current event information and allowing adjustment of the current event plan based on real-time information. The event management module can be linked with the sponsor management module, the marketing management module, and the venue management module to manage and adjust the current event information, the sponsor services, the marketing services, and the venue services associated with the current event plan.

In accordance with another aspect of the invention, there is provided a computer implemented method of planning and managing an event. The method can comprise: storing event data using a system module, with the event data comprising sponsor information, logo information, marketing information, products information, venue information, participant information, current event information, past event information, and financial information; providing sponsor services based on the sponsor information using a sponsor management module; providing marketing services based on the marketing information using a marketing management module; providing venue services based on the venue information using a venue management module; providing logo services based on the logo information using a logo management module; providing participant services based on the participant information using a participant management module; providing products services based on the products information using a products management module; and providing financial services based on the financial information using a financial management module.

In accordance with another aspect of the invention, there is provided a machine-readable storage having stored thereon, a computer program having a plurality of code sections, with the code sections being executable by a machine for causing the machine to perform the steps of: storing event data using a system module, with the event data comprising sponsor information, logo information, marketing information, products information, venue information, participant information, current event information, and past event information; creating a current event plan based on the event data using an event planning module; and managing execution of a current event plan based on real-time current event data using an event management module.

In accordance with another aspect of the invention, there is provided a method of planning and managing an event. The method can comprise: storing event data using a system module, with the event data comprising at least one of sponsor information, logo information, marketing information, products information, venue information, participant information, current event information, past event information, and financial information; providing at least one of sponsor services based on the sponsor information, marketing services based on the marketing information, venue services based on the venue information, logo services based on the logo information, participant services based on the participant information, products services based on the products information; and providing financial services based on the financial information using a financial management module in communication with the system module. The financial services can be updated in real time.

In the various embodiments, the current event information can be further comprised of event schedule information and event financial information.

In some embodiments, a logo management module can be provided to use the logo information to provide logo services. In other embodiments, a participant management module can be provided to use the participant information to provide participant services. In other embodiments, a products management module can be provided using said products information to provide products services. In other embodiments, a financial management module can be provided to use financial information to provide financial services.

In some embodiments, the event planning module can further comprise an event cloning module to create a current event plan using past event information. In other embodiments, the marketing manager can further comprise a signage management module being linked with the sponsor management module, the logo management module, and the venue management module to handle signage creation, signage location, and signage distribution using event data.

### BRIEF DESCRIPTION OF THE DRAWINGS

Embodiments of the invention will now be described by way of example only with reference to the following drawings in which:

FIG. 1 is a block diagram showing a high level overview of a system in accordance with an embodiment of the invention.

FIG. 2 is an exemplary screenshot showing an system manager e-mail interface in a system in accordance with an embodiment of the invention.

FIG. 3 is a flow diagram showing planning of a sporting event using a system in accordance with an embodiment of the invention.

FIG. 4 is a flow diagram showing further details in the planning of a sporting event using a system in accordance with an embodiment of the invention.

FIG. 5 is a flow diagram showing planning of Event Day Activities using a system in accordance with an embodiment of the invention.

FIG. 6 is a flow diagram showing Sponsorship Types Management using a system in accordance with an embodiment of the invention.

FIG. 7 is an exemplary screenshot of a Sponsorship Set Up chart in a system accordance with an embodiment of the invention.

FIG. 8 is a flow diagram for Sponsor Management using a system in accordance with an embodiment of the invention.

FIG. 9 is a flow diagram for Logo Management using a system in accordance with an embodiment of the invention.

FIG. 10 is an exemplary screenshot showing a tournament logo library in a system in accordance with an embodiment of the invention.

FIG. 11 is an exemplary screenshot showing a built in logo library in a system in accordance with an embodiment of the invention.

FIG. 12 is an exemplary screenshot showing logo edit and uploads in a system in accordance with an embodiment of the invention.

FIG. 13 is an exemplary screenshot showing a logo awaiting approval in a system in accordance with an embodiment of the invention.

FIG. 14 is a flow diagram showing how marketing is carried out using a system in accordance with an embodiment of the invention.

FIG. 15 is a flow diagram showing selection of Signs and Banners using a system in accordance with an embodiment of the invention.

FIG. 16 is an exemplary screenshot showing a banner template in a system in accordance with an embodiment of the invention.

FIG. 17 is an exemplary screenshot showing a banner edit in a system in accordance with an embodiment of the invention.

FIG. 18 is an exemplary screenshot showing a hole sign setup in a system in accordance with an embodiment of the invention.

FIG. 19 is an exemplary screenshot showing a hole sign assignment in a system in accordance with an embodiment of the invention.

FIG. 20 is an exemplary screenshot showing order setup for event day signs in a system in accordance with an embodiment of the invention.

FIG. 21 is an exemplary screenshot showing a additional event day sign ordering in a system in accordance with an embodiment of the invention.

FIG. 22 is an exemplary screenshot showing a venue interface in a system in accordance with an embodiment of the invention.

FIG. 23 is an exemplary screenshot showing course events in a system in accordance with an embodiment of the invention.

FIG. 24 is an exemplary screenshot of a participant website created using a system in accordance with an embodiment of the invention.

FIG. 25 is an exemplary screenshot of a participant website created using a system in accordance with an embodiment of the invention.

FIG. 26 is an exemplary screenshot of a participant website created using a system in accordance with an embodiment of the invention.

FIG. 27 is an exemplary screenshot of a participant website created using a system in accordance with an embodiment of the invention.

FIG. 28 is an exemplary screenshot of a participant website created using a system in accordance with an embodiment of the invention.

FIG. 29 is an exemplary screenshot showing posted view of participants in a system in accordance with an embodiment of the invention.

FIG. 30 is an exemplary screenshot showing organizer view of participants in a system in accordance with an embodiment of the invention.

FIG. 31 is a flow diagram show products selection and purchasing using a system in accordance with an embodiment of the invention.

FIG. 32 is an exemplary screenshot show browsing options for product selection in a system in accordance with an embodiment of the invention.

FIG. 33 is an exemplary screenshot showing apparel options in a system in accordance with an embodiment of the invention.

FIG. 34 is an exemplary screenshot showing detailed category information in a system in accordance with an embodiment of the invention.

FIG. 35 is an exemplary screenshot shot showing category results in a matrix view in a system in accordance with an embodiment of the invention.

FIG. 36 is an exemplary screenshot showing further product selection details in a system in accordance with an embodiment of the invention.

FIG. 37 is an exemplary screenshot showing product selection order summary in a system in accordance with an embodiment of the invention.

FIG. 38 is a flow diagram for Invoicing, Payment, and Backend using a system in accordance with an embodiment of the invention.

FIG. 39 is a flow diagram for order processing using a system in accordance with an embodiment of the invention.

FIG. 40 is an exemplary screenshot showing an email interface in a system in accordance with an embodiment of the invention.

FIG. 41 is an exemplary screenshot showing organizer view of prizes available on event day in a system in accordance with an embodiment of the invention.

FIG. 42 is an exemplary screenshot showing a finance overview in a system in accordance with an embodiment of the invention.

FIG. 43 is an exemplary screenshot showing accounts receivable in a system in accordance with an embodiment of the invention.

FIG. 44 is an exemplary screenshot showing payment record setup in a system in accordance with an embodiment of the invention.

FIGS. 45 through 56 are screenshots for a system in accordance with another exemplary embodiment of the invention.

### DETAILED DESCRIPTION OF THE INVENTION

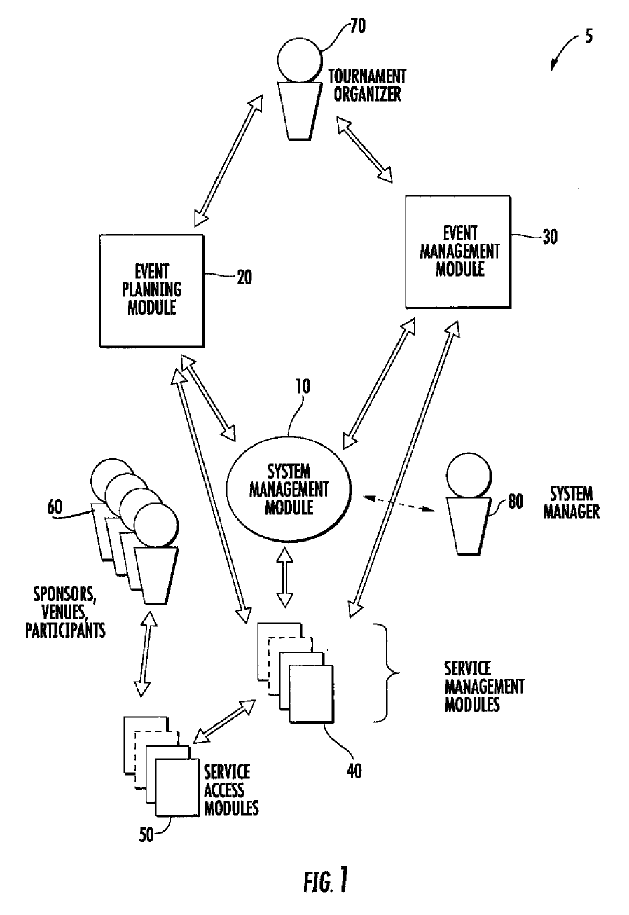

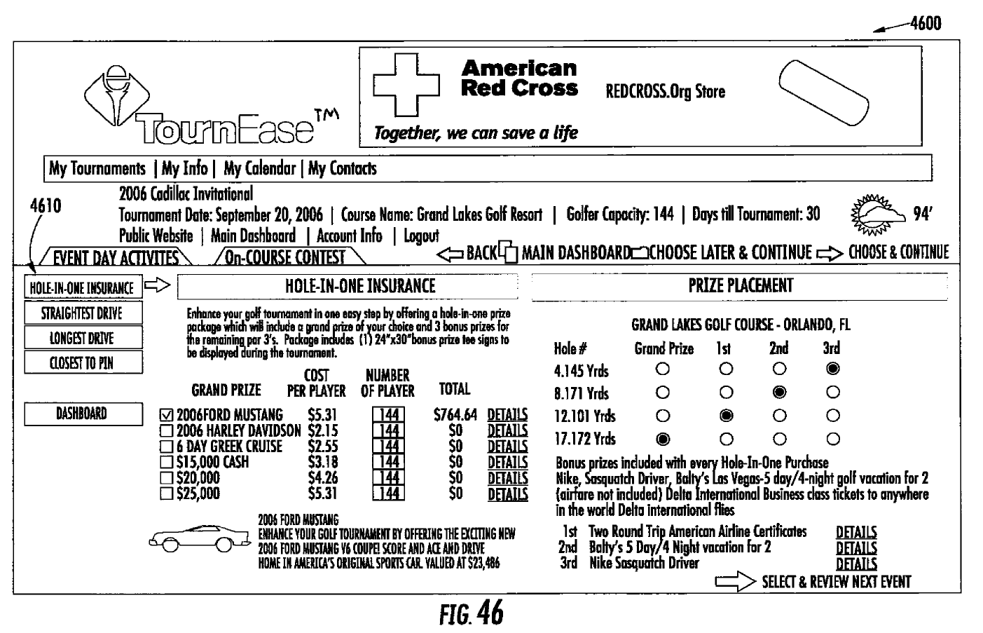

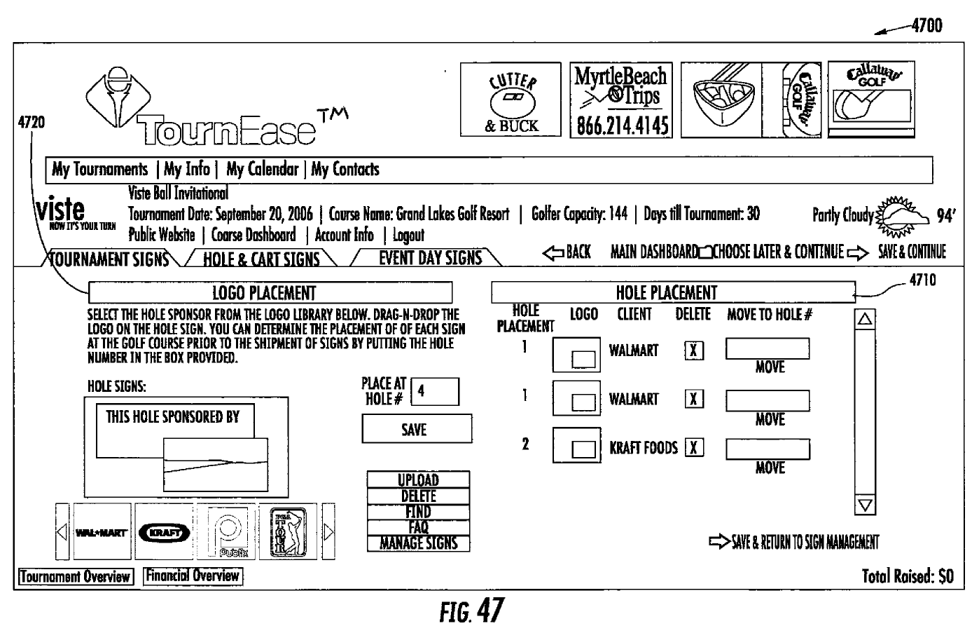

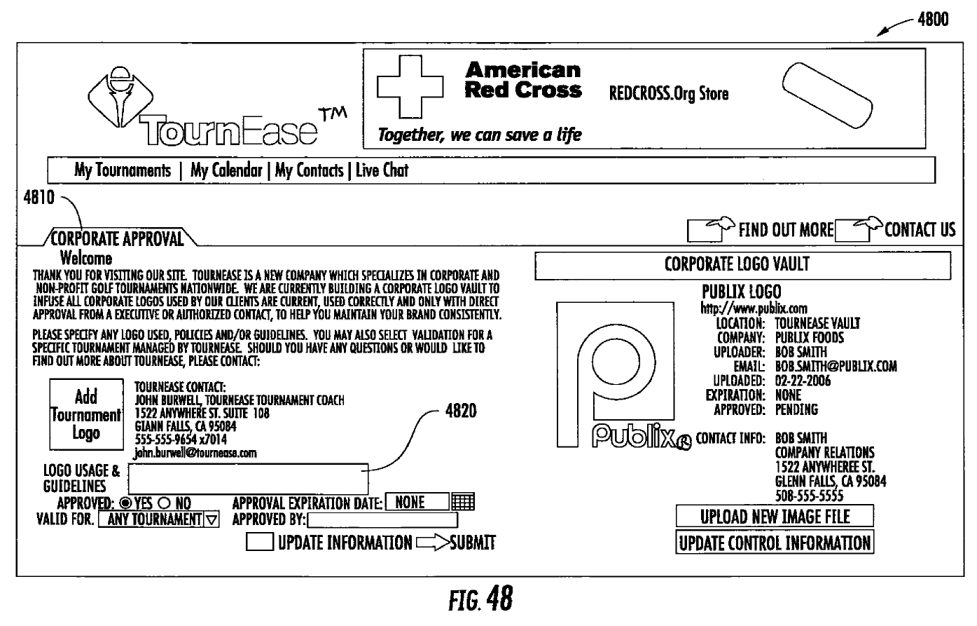

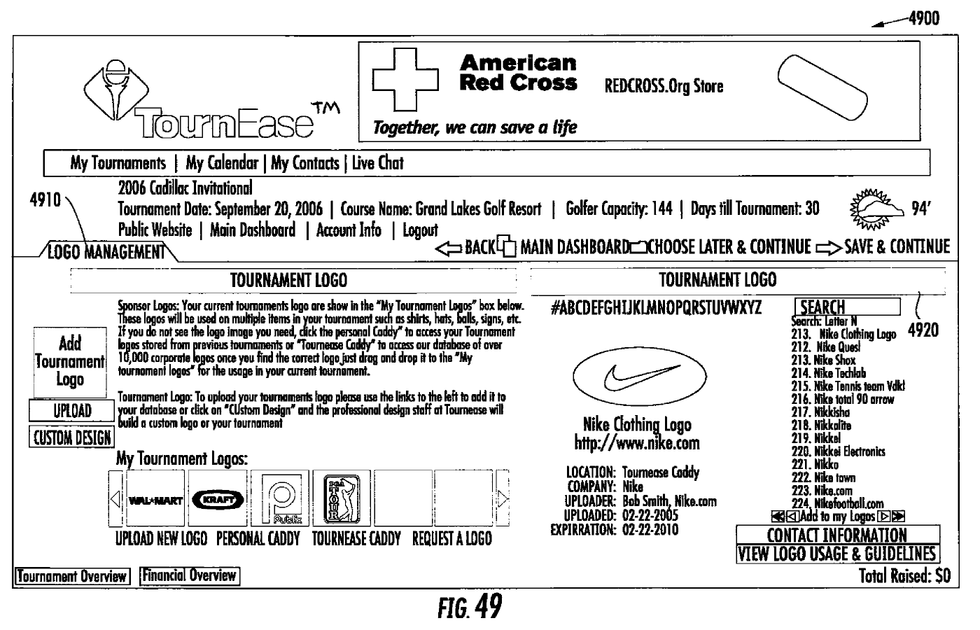

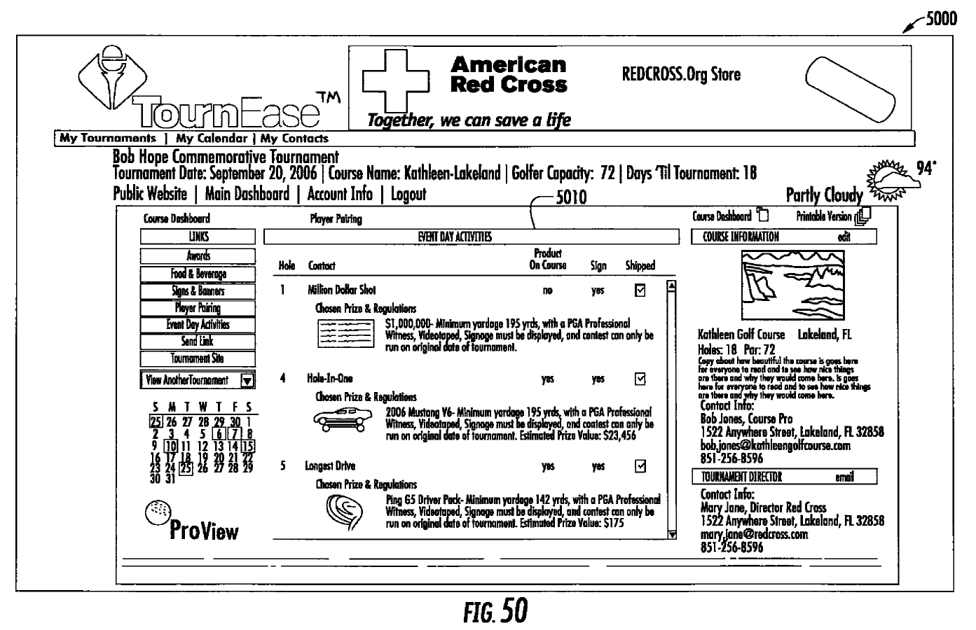

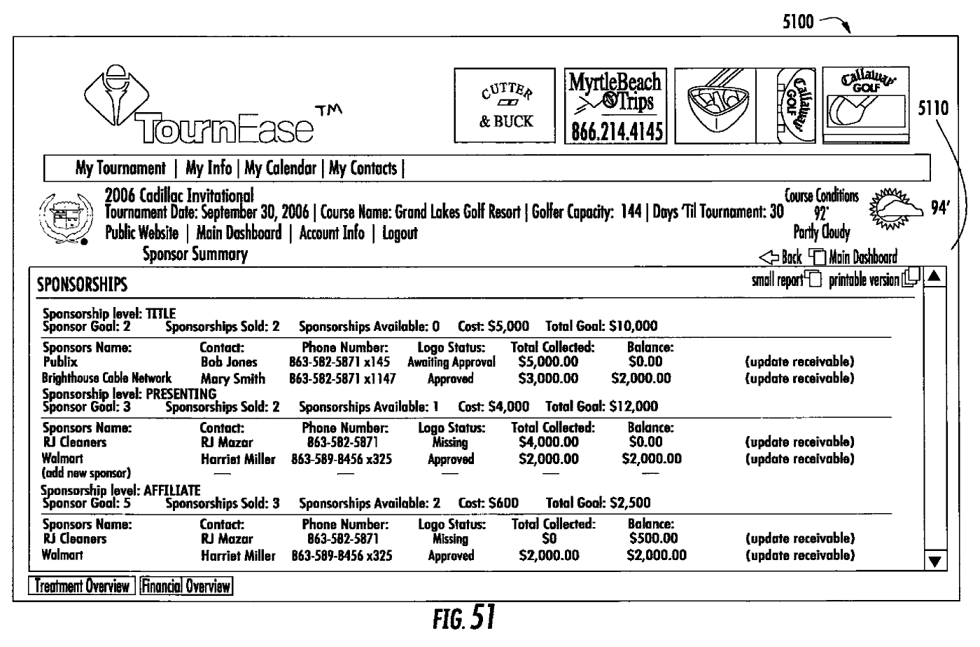

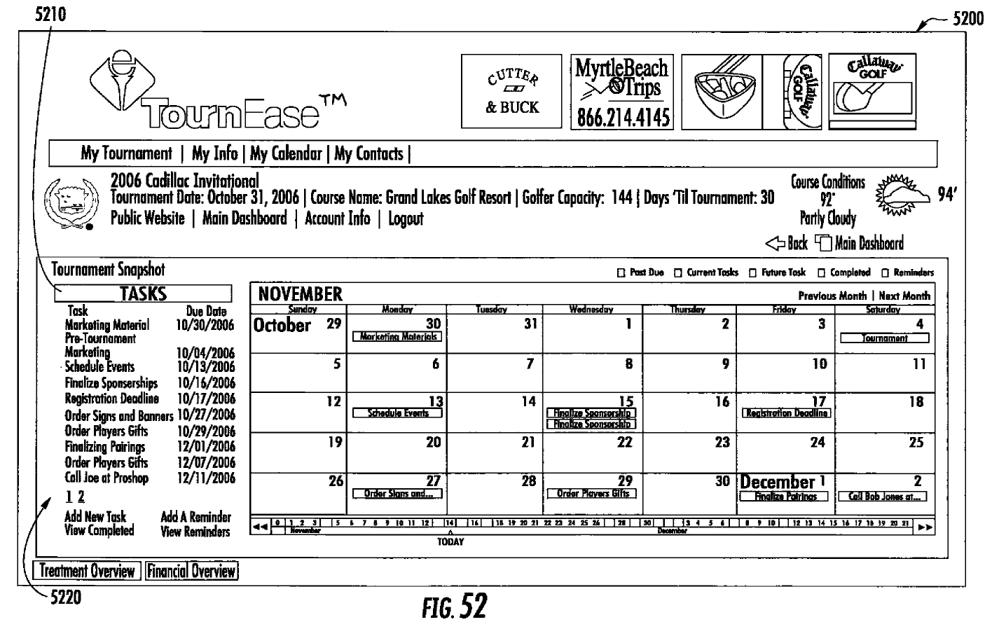

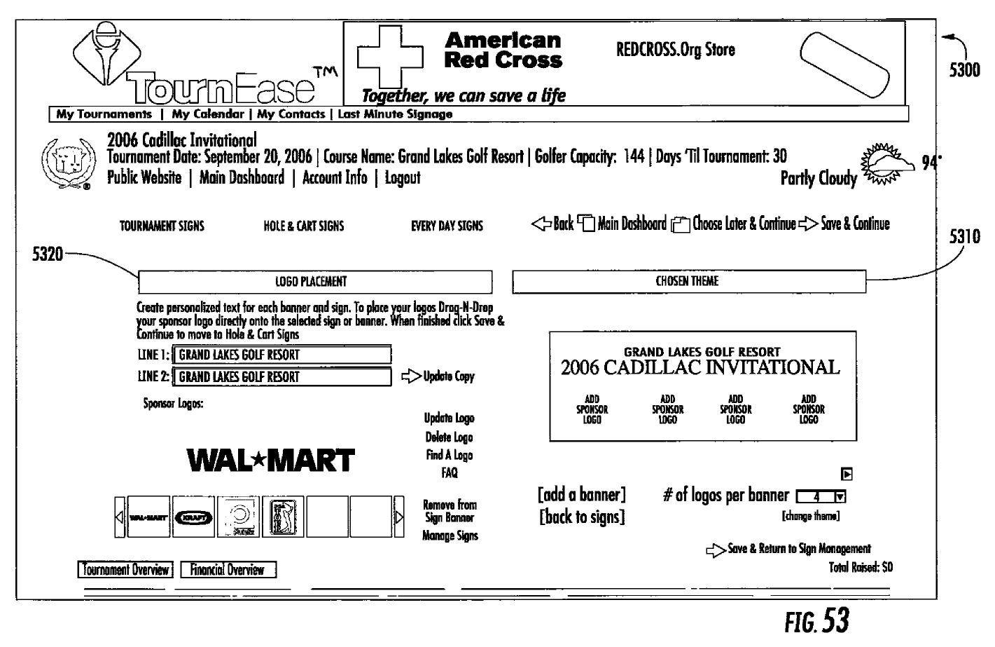

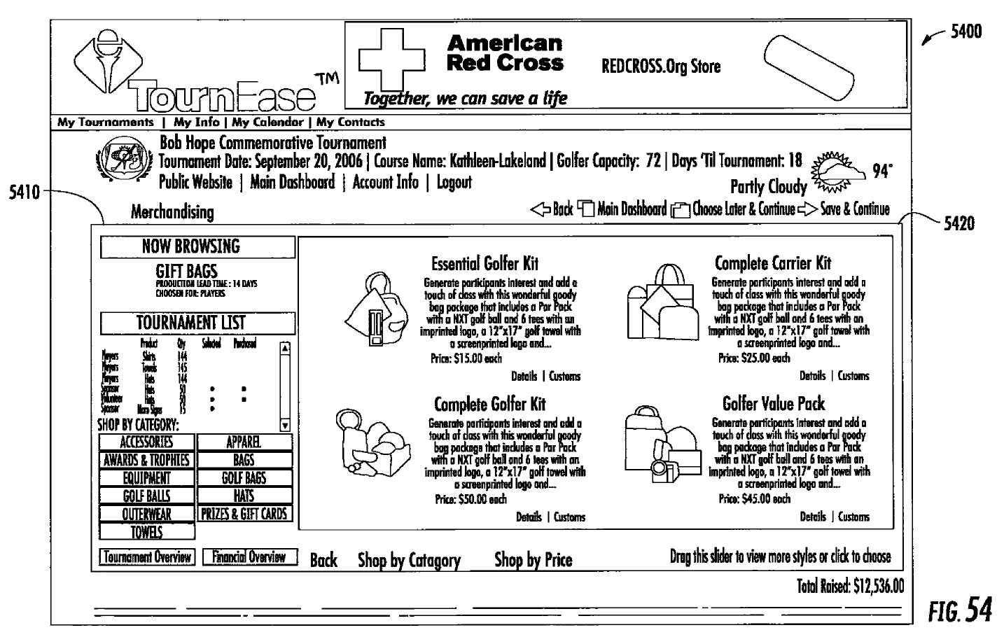

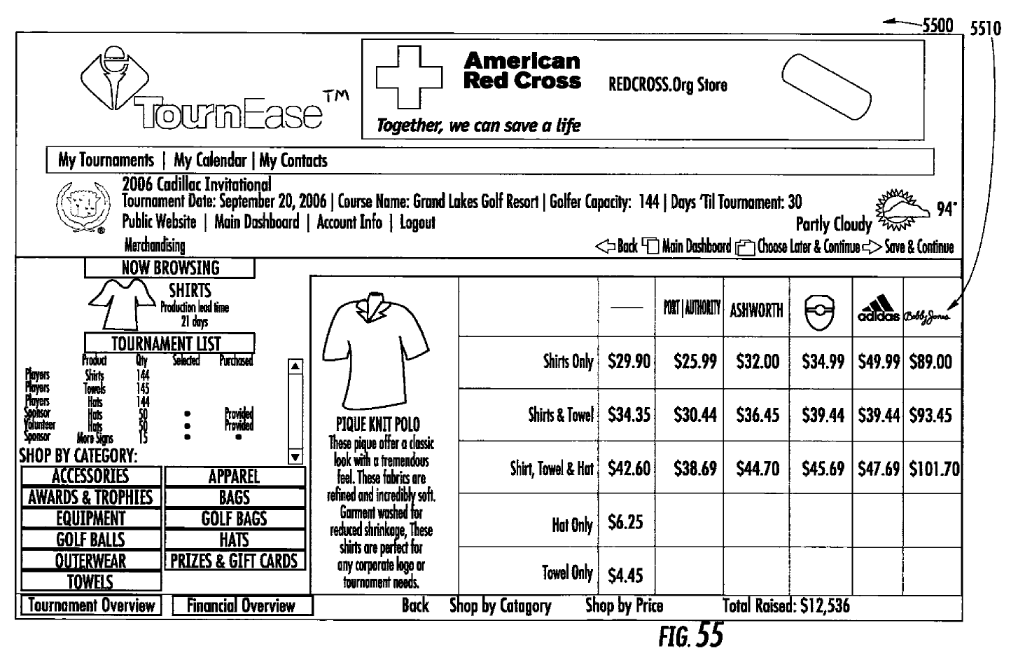

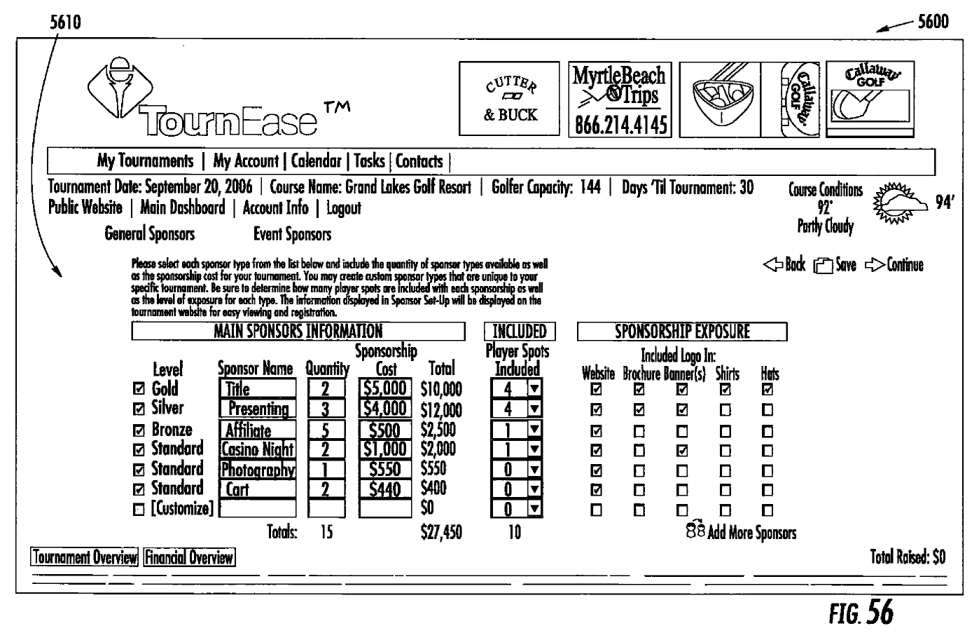

An event planning and management system in accordance with embodiments of the invention are described. In some embodiments, the system can be suitably implemented in a server system and used from multiple clients through a communication network, such as the Internet. Clients may be computer-based or web browser-based points of access for event organizers, sponsors, vendors, venue operators, or participants. Although the invention may be implemented to plan a variety of events, the invention will be described in terms of a system implemented to plan a sponsored golf tournament, as shown in the embodiments illustrated in FIGS. 1-56. The following description therefore references tournament management and planning, although the invention in not limited in this regard, and is applicable to any event management and planning situation.

As shown in FIG. 1, the system 5 can have a system management module 10, an event planning module 20, an event management module 30, a plurality of service management modules 40, and a plurality of associated service access modules 50 for third parties 60 to enter information into the system.

The system management module 10 can provide a centralized storage and retrieval management system of all types of event data for the system, including, but not limited to, sponsor information, logo information, marketing and advertising information, products and vendor information, venue information, participant information, past event information, and current event information. Such current or past event information can include, but is not limited to, all information associated with the current and past event, such as schedules or financial information.

The system management module 10 can be linked to the series or groups of modules. In the embodiment illustrated in FIG. 1, the system management module 10 can be linked to the event planning module 20, the event management module 30, and a plurality of service modules 40. The event planning module 20 can provide an interface for the organizer 70 to quickly and efficiently create a plan for the upcoming event using the information stored in the system management module 10. The event management module 30 can provide an interface for the organizer 70 to monitor the planning and execution of the event, as well as allow for adjustments of the plan when needed. The service modules 40 can provide an interface for the organizer 40 to create, provide, and associated event services. Such services can include, but are not limited to sponsor services, logo services, marketing and advertising services, venue services, participant services, financial services, and signage services. The service management modules 40 can also be linked to the event planning module 20 and the event management module 30. By linking these modules together, the organizer 70 planning or managing the event can quickly access and manage associated services before, during and after the event.

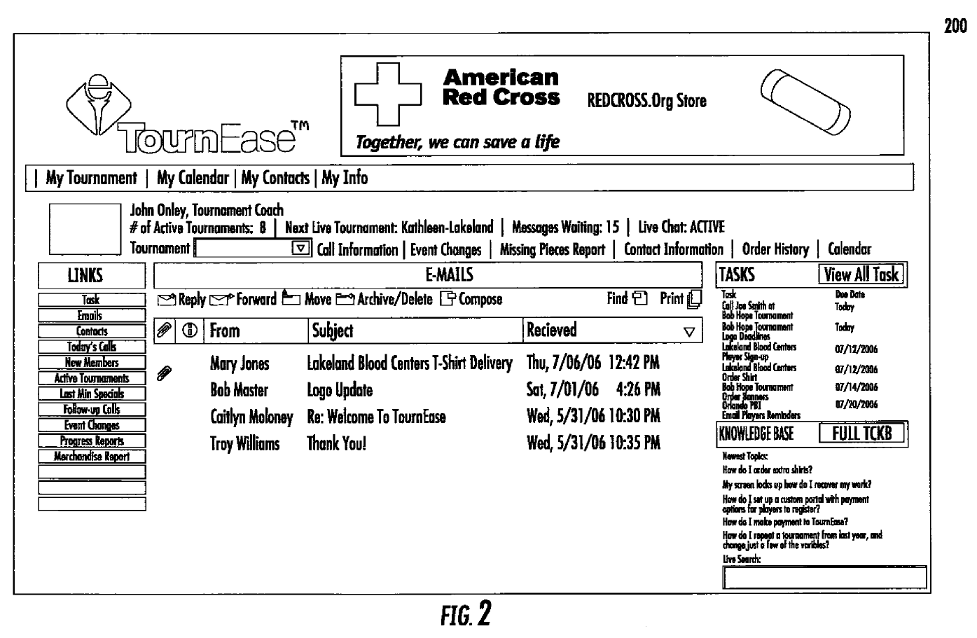

In the illustrated embodiment, the system 5 can be maintained or supported by a system manager or support specialist 80. The system manager 80 can have access to all aspects of the system 5 and can have the ability to generate reports from any module in the system. In these embodiments, a system manager interface 200 can be completely contained in the system 5, including the interface to communicate with a tournament organizer 70, as shown in FIG. 2. The system manager 80 can serve principally in a support role for the organizer 70, therefore in the various embodiments, the majority of the modules can be adapted to be intuitive for the organizer planning and managing the event.

In some embodiments of the invention, the event planning module 20 can be linked to the system management module 10 and to the service management modules 40, as shown in FIG. 1. This can allow a tournament organizer 70 to plan an event, access all event information, as well as plan all associated services.

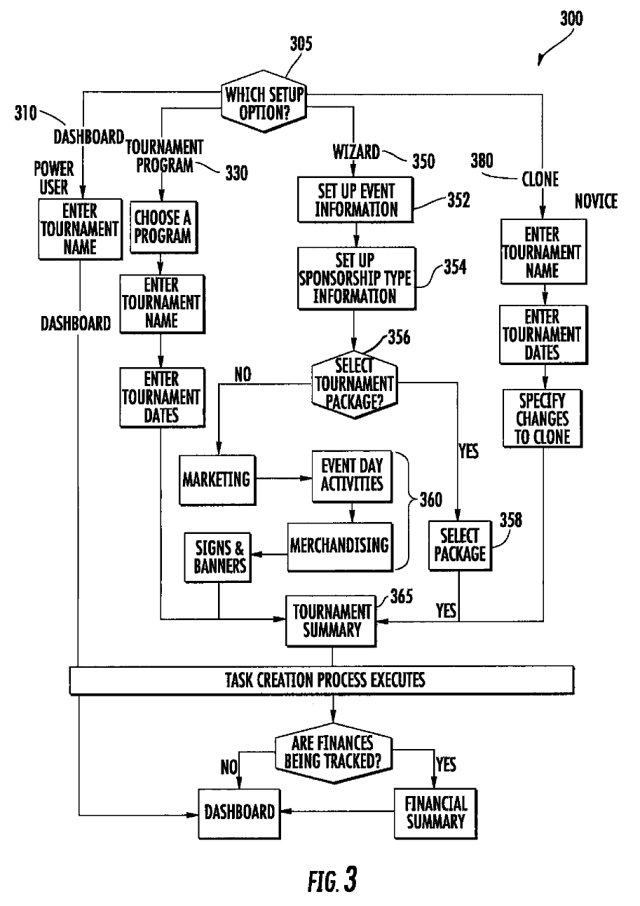

As shown in process 300 illustrated in FIG. 3, the organizer 70, through a client, may set up a new tournament using the Tournament Builder or Setup Wizard 350, in which all information necessary for the tournament is entered by the tournament organizer 70 through the event planning module 20. In the illustration in FIG. 3, upon accessing the event planning module 20 to set up a tournament, the tournament organizer is presented with event planning options in step 305: go directly to the event management module 30 (step 310), set up a new tournament from an existing program (step 330), use the Tournament Builder (step 350), or “clone” a previous year's tournament (step 380).

In the illustrated embodiment, the Tournament Builder 350 provides the tournament organizer with a step by step mechanism for setting up a tournament. The sequence of steps in the Tournament Builder 350 can be adapted to be predetermined, static, and non-configurable while still maintaining a high level of planning in the Tournament Builder. The Tournament Builder 350 can include entering event and sponsorship information in steps 352 and 354. A tournament package can be selected in step 356 with various packages being offered in step 358. Where a user desires to provide individual or customized information including marketing, activities, merchandising and signage, step 360 provides for such selections. A summary of the tournament is generated in step 365.

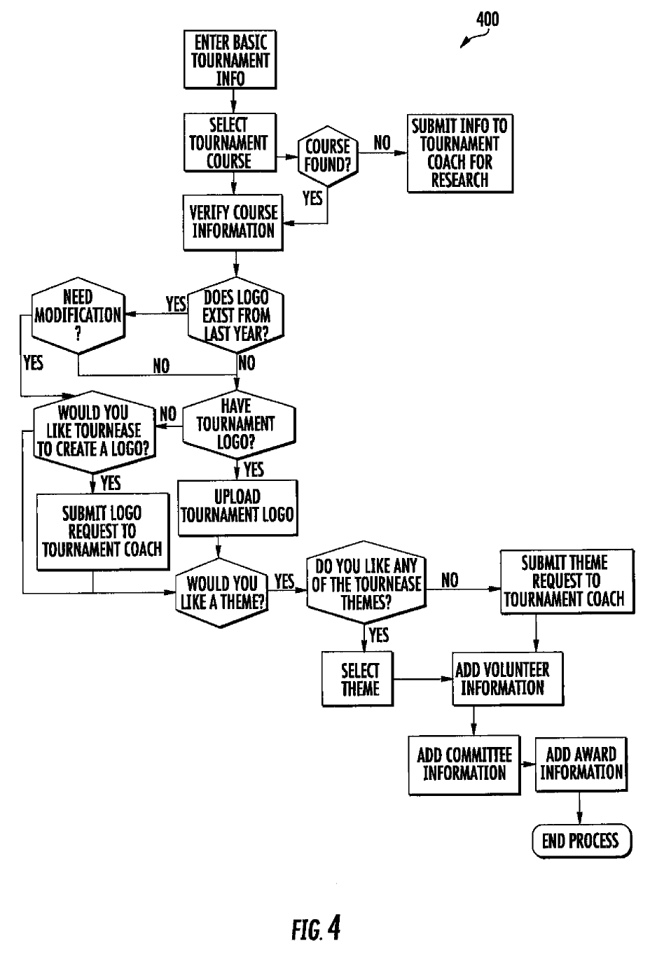

As illustrated in process 400 of FIG. 4, the event organizer 70 can choose to enter all tournament details, including, but not limited to: course selection, tournament logos, volunteer information, committee information, or tournament marketing themes. When the tournament organizer 70 selects a tournament marketing theme, other choices in the event planning module 20 or other service modules can be limited or automatically chosen so that all aspects of the tournament comply with the chosen marketing theme.

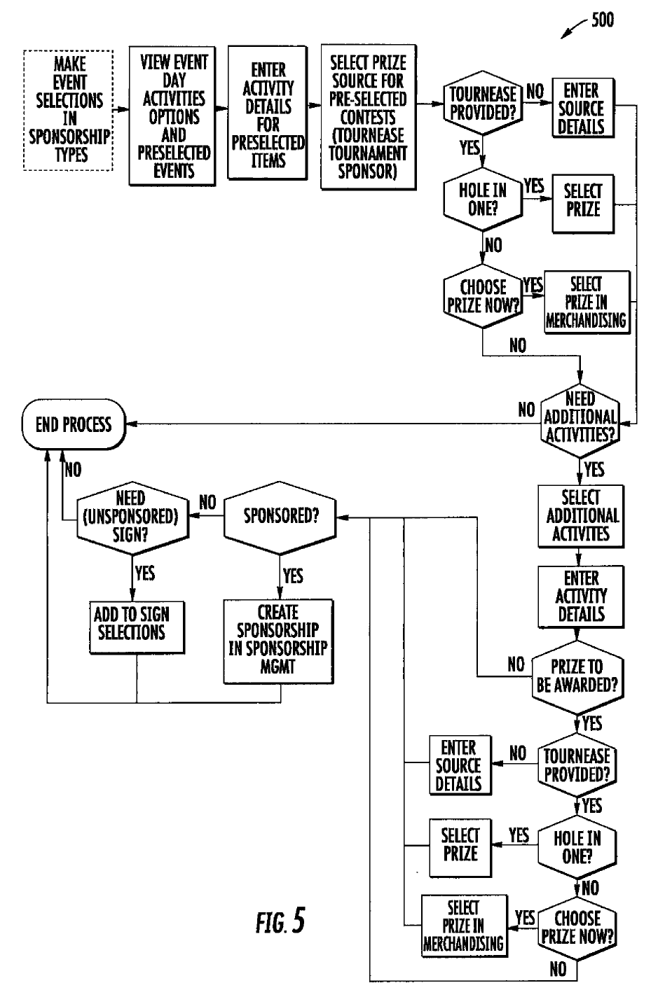

The organizer can also select, as shown in process 500 of FIG. 5, to add special events to the tournament and specify prizes, sponsors, and signage for those events.

In the illustrated embodiment, the Tournament Builder 350 further provides the ability for the tournament organizer to select from pre-determined packages of options and products. Selecting a package bypasses several Tournament Builder 350 steps and takes the tournament organizer directly to the tournament summary, as shown in FIG. 2. Event Setup and Sponsorship Type Setup can also be presented to the tournament organizer when utilizing the Tournament Builder 350, regardless of package selection, but electing a package would not prevent the tournament organizer from making subsequent changes to options and products. If a package is not selected, the tournament organizer can proceed through the steps of the Tournament Builder 350. Each step in the Tournament Builder 350 can allow the tournament organizer to specify the options that will be included in the tournament, as well as specifying the details relating to those options, in the associated service management modules 40. When entering details for a particular option within a service management module 40, the tournament organizer 70 can be placed at the same screen of the service management modules 40 that the tournament organizer could also get to via the menu or event management module 30.

The Tournament Builder 350 in the illustrated embodiment can also provide the tournament organizer 70 with visibility into the complete Tournament Builder process, such as showing “grayed” or “blurred” icons and/or breadcrumb navigation for previous and future steps and allowing clicking of icons or breadcrumbs to navigate to the associated step in the Tournament Builder. The tournament organizer 70 may go back to previous steps in the Tournament Builder 350 that have already been completed or skipped. The tournament organizer 70 may skip steps in the Tournament Builder 350. The tournament organizer 70 may exit the Tournament Builder 350 at any point, saving the information that has already been entered.

In the illustrated embodiment new tournaments can be created from existing tournament programs. Programs can be chosen from a list including: standard programs provided for in the system, programs provided by the tournament organizer's organization, or programs previously saved by the tournament organizer 70. Upon choosing a program, the tournament organizer 70 can be prompted for tournament name and tournament dates. All other tournament data is provided by the program, but can be adjusted from the tournament summary or from the event management module 30 (to be discussed later).

A new tournament can also be “cloned” from a prior year's tournament as shown in process 300 of FIG. 3. Upon choosing to clone or repeat a tournament, the tournament organizer 70 is prompted for the tournament name and tournament dates. The event planning module 20 may also provide the organizer 70 with the “most common” modifications made by other tournament organizers when planning a repeat event. The tournament organizer 70 may also select which changes will be made and then the tournament organizer may link to the appropriate service module in order to make changes. However, if a change is selected, but not immediately changed, a task list item (to be discussed later) can be created.

The Tournament Builder 350, package selection, and cloning paths of process 300 can terminate at a summary of the tournament created. In the illustrated embodiment, the tournament summary can indicate: the options that have been selected or the customization of the event, whether or not details have been provided for each option, and a summary of those details. For each option, a link back the screen to manage that particular option or customization can be provided. From the tournament summary, the tournament organizer 70 can also have the following navigation options: links to each individual tournament option or customization, in order to modify selections, customization, details (see previous requirement) or go to the event management module 30. In the illustrated embodiment, no matter which path is chosen to create a tournament, the task creation engine (See Alerts, Reminders, and Timeline) executes to ensure that all resulting tasks are immediately viewable by the tournament organizer 70.

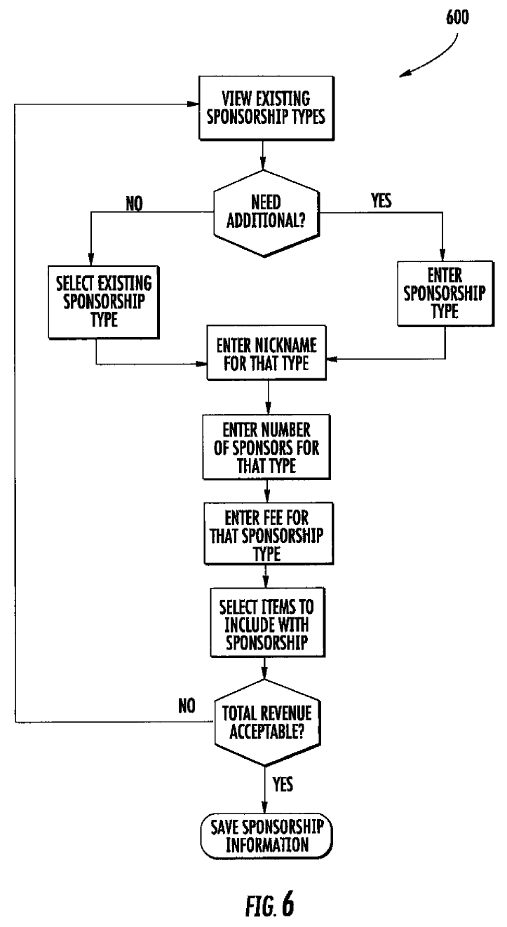

The tournament organizer 70, through the Tournament Builder 350 or the sponsor management module, may also set up and allow customization of sponsorships. As illustrated in process 600 of FIG. 6, when the tournament organizer 70 accesses the sponsor manage module, a chart of available sponsorship types to select or customize can be provided in a sponsorship set up interface. Once a sponsorship type is selected or customized, the tournament organizer 70 can specify a nickname for the sponsorship (event sponsors only, not product sponsors). The Nickname can be displayed for the sponsorship type everywhere else in the system. The tournament organizer 70 can also specify: the number of sponsors for that type, the fee associated with that sponsorship, and the items that are included with that sponsorship type. Such items that can be included with that sponsorship type could be: the number of player or participant spots allocated in tournament, whether to include an ad on website, whether to include a logo on brochures, whether to include a logo on banners, whether to include a logo on shirts, and whether to include a logo on hats. In the illustrated embodiment, a running sponsorship revenue total can appear on the screen. The total will be calculated as the sum of the quantity multiplied times the fee for all sponsorship types selected.

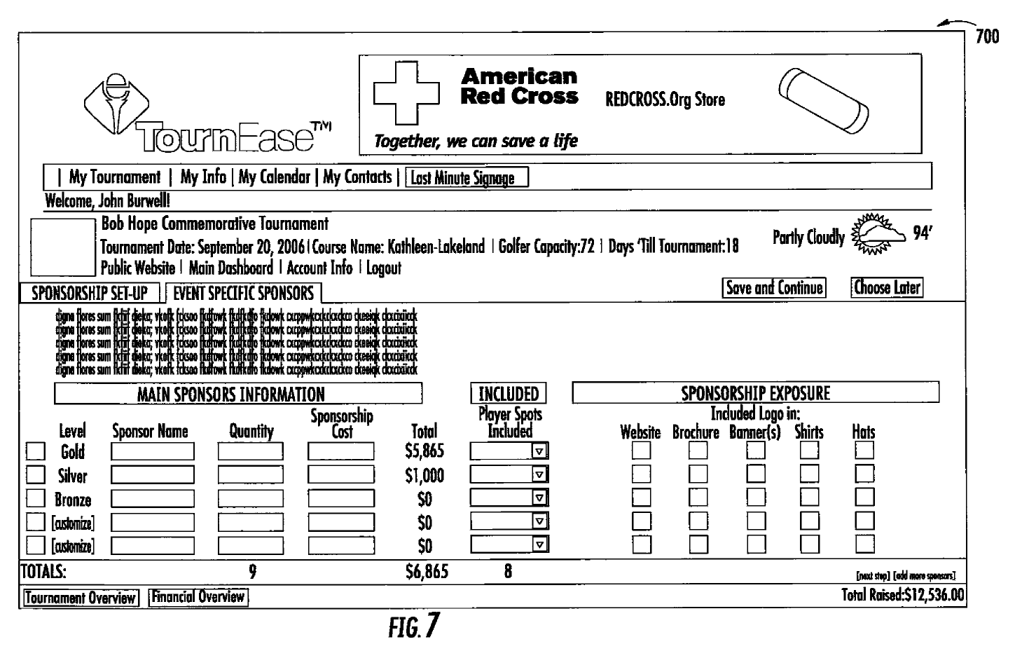

As shown in an exemplary screenshot 700 of the embodiment illustrated in FIG. 7, a check box can appear to the left of each type of sponsorship. The row can be editable once it is selected. The total for the row will be the quantity multiplied by the sponsor amount. The Player Spots Included column can be a dropdown list. The On Website, Logo in Brochure, Logo on Banner, Logo on Shirt, and Logo on Hat columns can also be check boxes. The Nickname can be a text box and the Quantity can be a text box adapted to accept only numeric data. All of these features can be customized by the user.

In the illustrated embodiment, there can be a separate Sponsorship Set Up interface for the product and activity sponsors. A check box can appear to the left of each type. The row may only be editable once it is selected. The total for the row will be the quantity multiplied by the sponsor amount. Quantity can be a text box, and can be adapted to only accept numeric entry. Sponsor Amount can also be a text box, and can be adapted to only accept currency-formatted data. The Participant Spots Included column can be a dropdown list of numbers. The Sign Included and Product columns can be check boxes. The Product column can also provide the tournament organizer 70 an indication that the tournament organizer 70 will be prompted later for purchase and/or specifying that the product is being provided by someone. Also, there can be a question mark to the left of each sponsorship type that pops up an item description and a link to the store.

In the illustrated embodiment, the Sponsorship Set Up interface can further allow the tournament organizer 70 to add an unlimited number of new sponsorship types. Initially there can be 2 blank rows to signal to the tournament organizer 70 that they can add additional sponsorship types. Additional rows can be accessible through an “Add new type” button. Totals for each of the items to include can be provided. These totals would be reflected in the respective totals for the specific item. For example, the Signs and Banners section could reflect the number of signs and banners that have been selected here. Each row for a sponsor type can also have an optional link to set up and associate the specific sponsor to that type. The Sponsor Management module would be initiated by that link. Additionally, a message can be displayed indicating that the actual sponsors (companies) can be managed separately and later.

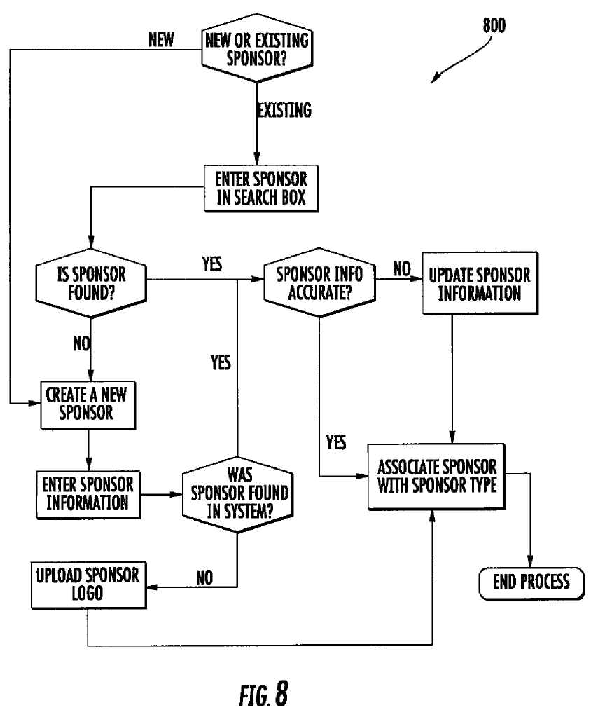

Once a sponsorship is setup, the organizer 70 can then access the sponsorship management module directly to manage and adjust the sponsorship. In the process 800 illustrated in FIG. 8, sponsor management can provide the following functionality: addition of new sponsor information, deletion of existing sponsor information, or association of sponsors to sponsorship types. A sponsorship interface can be provided to display what sponsorship opportunities exist and which are filled.

In the illustrated embodiment, sponsorship types can be driven entirely from the sponsorship management module directly. Additional quantities of an existing sponsorship types can be updated on the fly through the sponsor management module. For example, if “Title Sponsor” is listed as a sponsorship type, but all slots are filled, the tournament organizer 70 may increment the number of slots directly from this interface. Additional sponsorship types that do not already exist must be added and a link can be provided from this screen. For example, for each unfulfilled level, a link is shown to add a sponsor. Alternatively, the tournament organizer 70 may add a sponsor to multiple sponsorship types at once by selecting multiple sponsorship opportunities and selecting “add sponsor to multiple”. The sponsorship management module can also provide an Add Sponsor screen consisting of the following: a search box to search from the list of previous sponsors used by the tournament organizer 70 and/or tournament, and sponsors that have already been established for this tournament or the ability to add a new sponsor. A link to the logo management module can also be provided to request a logo from a sponsor which generates an automated email to the sponsor. Additionally, while the tournament organizer 70 is entering sponsor information, the system can attempt to match what is entered by the tournament organizer 70 to other records in the database and suggest sponsors that may already be in the database to prevent duplicate entries.

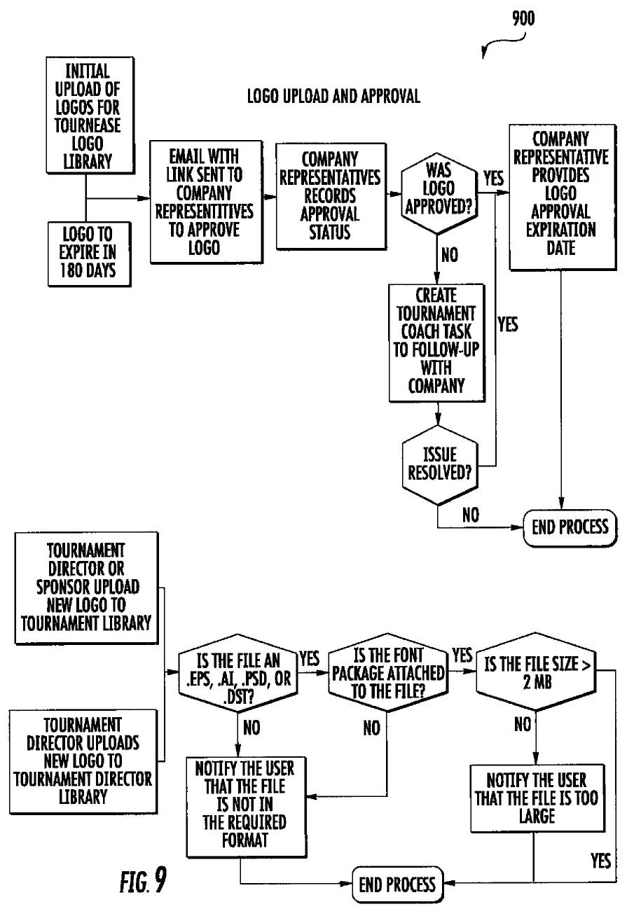

As discussed above, it is necessary to use and manage sponsor logos. In the various embodiments, a logo management module can be provide to handle logos and associated information, as shown in process 900 of FIG. 9. In the embodiment illustrated in FIG. 9, the logo management module performs several major processes. First, the module performs logo selection/upload from various other modules, such as event planning, sponsor management, products and merchandising management, and signage management modules. Additionally, the logo management module also includes processes required for logo approval and logo placement on products. In the illustrated embodiment, logos can be organized into categories (referred to as libraries) that can define their accessibility to the tournament organizers 70.

The logo libraries can include a system provided logo library. This can be a global library consisting of sponsor logos from major national companies. This library can be searchable by all tournament organizers 70, but is maintained by the system. In the illustrated embodiment, organizers 70 would not add, update, or delete any data in the system logo library. Another library can be an organizational logo library, in which logos can be provided, and in some cases mandated, by an organization planning multiple tournaments. Such a library can be searched by all tournament organizers 70 within an organization. The library could also be maintained by the system. Organizational representatives would be responsible for uploading and deactivating logos to the organizational library. For example, a representative from the Red Cross would be responsible for uploading and deactivating the logos for the Red Cross logo library, however the system manager 80 may perform this function as well.

Another type of logo library used by the logo management module can be a tournament logo library, in which Sponsor logos that have been selected and/or uploaded for the specific tournament being planned are stored. This library can also contain the selected tournament logo, if any (see FIG. 4). In one embodiment, this library can be searched and maintained by the organizer 70 within the currently selected tournament only. The can also be an organizer 70 logo library, comprising a personal library of sponsor logos from all tournaments that the organizer 70 is planning, as well as logos from previous tournaments. This library would be searchable and maintained by individual tournament organizer 70 only. In such a library, tournament logos can be automatically added for every tournament that the tournament organizer 70 is planning, but the organizer 70 may remove logos from the tournament organizer logo library at any time. In the illustrated embodiment, logos can exist in multiple libraries at once. For example, a logo might exist in the system library, but also pulled into multiple tournament and tournament organizer libraries. The tournament organizer 70 can also delete or deactivate logos from their current tournament or tournament organizer's logo library. If the logo was pulled from the system library, then it is deactivated from the tournament and tournament organizer libraries

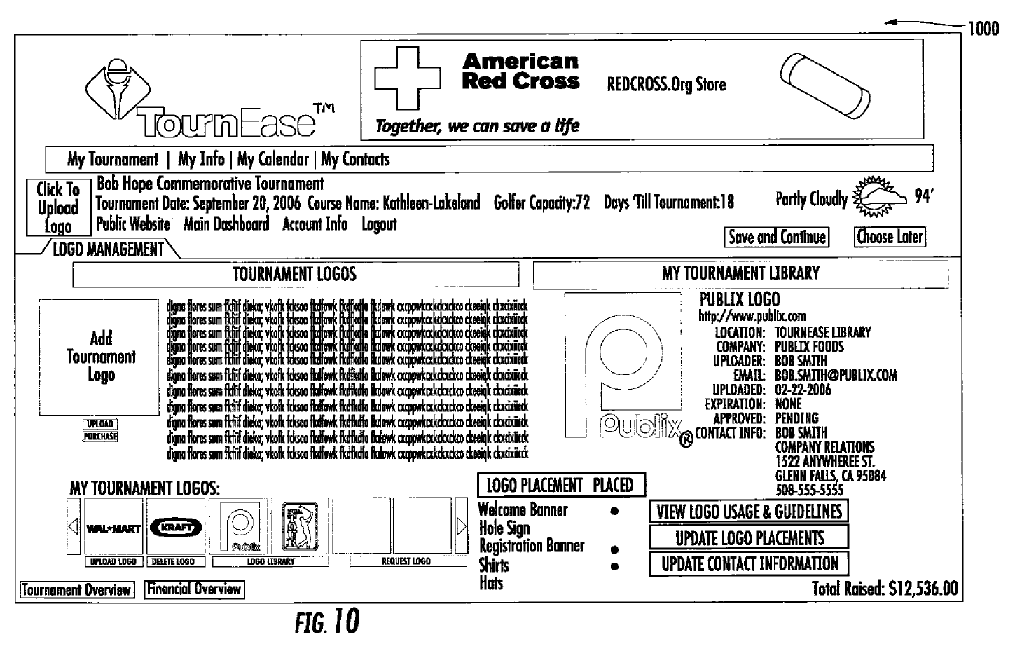

As shown in the exemplary screenshot 1000 in FIG. 10, the tournament organizer 70 can also view all logos for a particular tournament in a tournament logos view. The organizer 70 can visually display logos and view them in various sizes necessary for decorating products. The display can also include: company name, logo name, description and usage guidelines, whether or not the logo is approved, where the logo came from, who uploaded the logo, which library it is stored in, contact information for a sponsor logo representative, and a list of items the logo has been placed on (e.g. signs, apparel).

In the various embodiments, the tournament organizer 70 can also have the ability to select multiple logos for approval (see below). Additionally, an automated email can be generated for the logo contact with link to a service access module through a client in order to register an approval or disapproval. The tournament organizer 70 also has the ability to upload and/or select additional logos for the tournament. The tournament organizer 70 may also upload additional logos, or select from the one of libraries. Additionally, logos may be added as new logos or replacements for existing logos. Replacement logos can take effect on any products where the logo being replaced has been placed. However, logo replacement would not be allowed after products have been ordered.

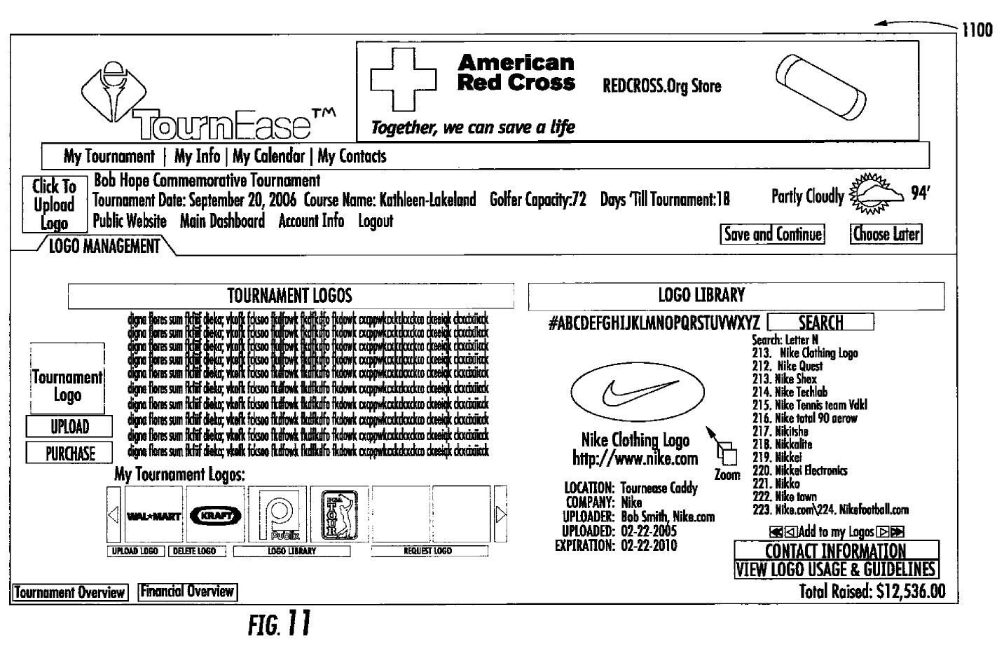

As shown in the exemplary screenshot 1100 in FIG. 11, a logo search interface can be provided. The tournament organizer 70 could search any combination of logo libraries (see above), including “All”, or could search by logo name, company name, description or keywords, and whether approved or not. The logo management module would not necessarily prevent the usage of unapproved logos, but the system would keep track of any time an unapproved logo is used. Logos could also be added to the tournament logo library from the search results. Logos added to the tournament library can be displayed in other modules where logos are added to products (e.g. signs and banners). Logos that are selected from the system library may be “locked” from all underlying changes to the logo in the system library, but the tournament organizer 70 would be notified of any changes. For example, if a logo is deleted from the system library, all organizers of tournaments where the logo is currently being used are notified, but the logo is not automatically removed or altered in any way. However, for any logos pulled from the system logo library, the tournament organizer 70 may be required to specify their specific sponsor contact, as this likely differs from the national contact specified in the system library

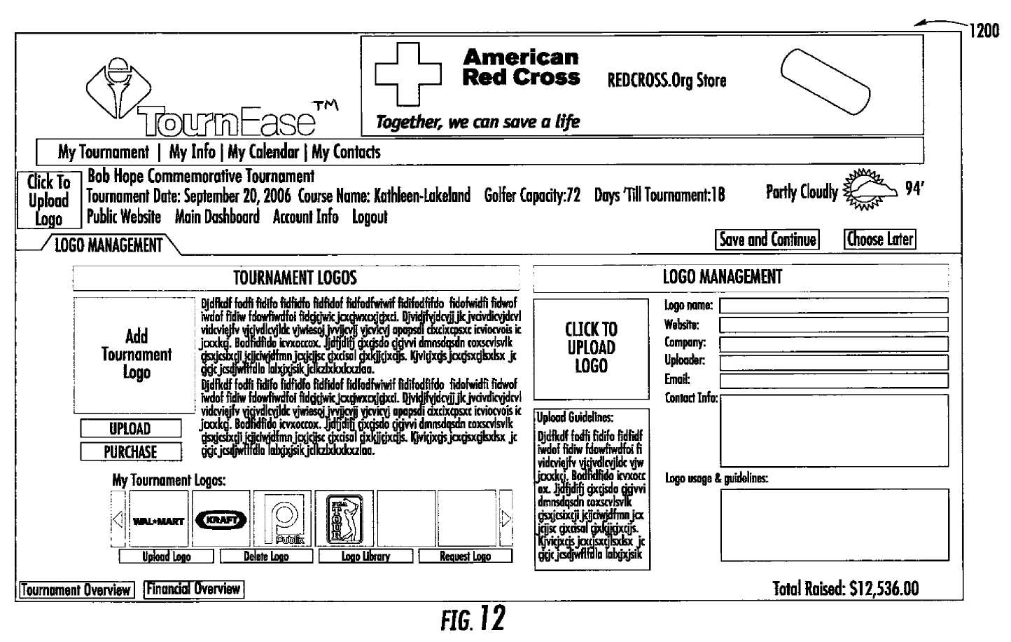

As shown in exemplary screenshot 1200 in FIG. 12, the tournament organizer 70 may also upload new logos. In the illustrated embodiment logos uploaded by the tournament organizer 70 would be placed into tournament and tournament organizer logo libraries. A system manager 80 would also be able to upload logos to any of the logo libraries, except for the tournament organizer library attributes specified for uploaded logos include: company name, logo name, logo file, digitized file, description and usage guidelines, logo contact information, and keywords. The uploaded logo would then immediately be converted to a lower resolution .jpg file for usage in the Logo management module interface. Any other conversions would be performed on an as-needed basis depending on where the logo is used (e.g. apparel, signs).

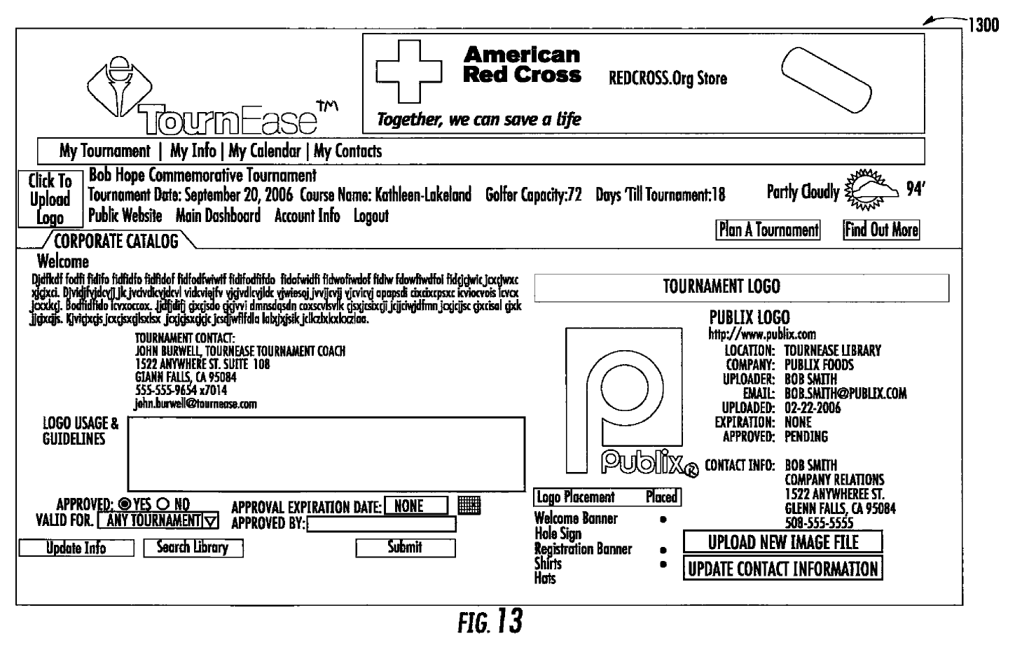

In the illustrated embodiment, all logos could also be verified and maintained by a sponsor representative, as shown in the exemplary screenshot 1300 in FIG. 13. For logos uploaded by the tournament organizer 70, the logo management module could provide for sending a verification email to the contact listed for the logo. A system manager 80 could also use the same interface to initiate approval emails for the logos in the system logo library.

The Logo approval can consist of a page that is link-able from an email, which accesses the logo access service module. The link could bring the approver directly to a page where the logo they have been asked to approve is displayed. In cases where the approval is specific to a tournament, the following additional non-editable data can be provided on this page: tournament name, tournament description, tournament date, and tournament organizer contact information. For approvals from the system logo library, which are not tournament specific, the following non-editable data may be provided: How many tournaments the logo has been used in, including a list of tournaments where the logo was used, with a link to tournament website if it is still available. The interface can comprise the following fields are to be completed by the approver: whether to approve or not, description/usage guidelines, approval expiration date, logo replacement, and whether to have the system generate a logo.

The logo management module can also monitor logos and upon expiration of an approval, the logo contact can be automatically notified and a new approval can be sought with logo approval email. The module can also allow the approver to access the module at any time to update a logo. However, updates to logos by approvers do not automatically change the logos in tournament or tournament organizer libraries. Tournament organizers 70 would be notified of these changes on the task List in the event management module 30, so that they may replace the logo using the logo management module.

Additionally, the tournament organizer 70 may solicit a logo from a known sponsor entered into the sponsor management module. In such embodiments, an email would be sent, similar to the approval process and the same interface could be used as above for sponsor approvals. However, no logo is displayed, unless the Tournament organizer 70 has chosen one from the system library to suggest to the sponsor.

In the illustrated embodiment, once logos have been approved, Logos may be placed on products by the tournament organizer 70. A list can be displayed of items that have been selected in the products module and allow logo placement. For items with multiple logo locations, columns can be displayed with multiple boxes where logos can be dragged to. Such columns can be dynamically generated based on the characteristics of the products. For example, if a golf ball has 2 locations, then 2 locations are displayed. If a shirt has 5 locations (2 sleeves, 2 chest, yoke), then 5 columns are displayed, but for example if a particular Nike shirt has a “swoosh” on the left sleeve, this location is not available for a logo. Where possible, a standard product image can be displayed that clearly indicates where the logo placements would be (e.g. identifies the “yoke” area of a shirt). Where available, a product information sheet can be provided for each particular item. This information is provided in the product management module, to be discussed later. If an organizer 70 wants to add text under a logo, it may require the generation of a new logo.

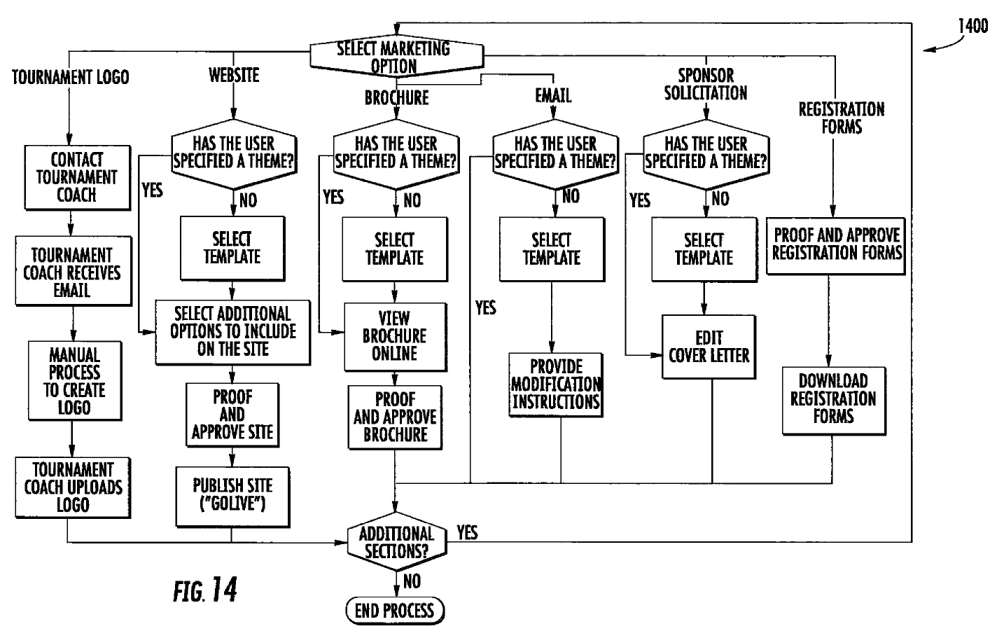

In the illustrated embodiment, marketing and advertising of the tournament is managed through a marketing management module, as shown in process 1400 of FIG. 14. The module could provide the following options for the tournament organizer 70 to choose and create: a logo for the tournament, a website for the tournament, brochures, email templates, sponsor solicitation templates, and registration form templates.

In the illustrated embodiment, the logo for tournament option would be available if the tournament organizer 70 did not upload a logo at event set up. The tournament organizer 70 can also have the option to create a dynamically generated website for the tournament. Additionally, the site can be flexible enough to change as more information about the tournament becomes available and/or site features become relevant or available. For example, registration could be disabled on the tournament website until the registration window. Another example would be that the site may not specify the date of the tournament initially, but this information appears as soon as it is specified by the tournament organizer 70 during event planning. Website templates can be available for the tournament organizer 70 to determine how they want the website to look visually. Previews of the templates can also be viewable by the organizer 70.

A shown in the illustrated embodiment, the basic website could contain, but not be limited to, the following information: contact information, tournament logo, tournament start date, tournament end date, tournament format, tournament description, directions link, charity or corporate web site link, registration open date, registration description, and a registration PDF file. Additionally, the organizer 70 could have the option to deselect and not include specified pieces of information.

The organizer 70 could also have the ability to add additional website features. For example, the website could provide participant registration functionality. Access codes could be generated and added to other marketing materials to limit participant registration access to only those that have received a code. Also, different codes could be generated for each marketing channel (email, brochure) in order to track how registrants found out about the tournament. In addition, the organizer 70 could add the option to eliminate ads from the tournament website, provide sponsor registration functionality, or display pictures from previous tournaments. At any point, the website may be previewed by the organizer 70, with the preview incorporating all of the option selected so far. Finally, the tournament organizer 70 could be provided a “Go Live” option when they are satisfied with the website preview to publish the site for public usage.

The tournament organizer 70 can also have the option in the marketing management module to create brochures for their tournament. The organizer 70 can be given template options for the layout of the brochures. In the illustrated embodiment, templates may be displayed as thumbnail images. Clicking on such a thumbnail image would display an enlarged view of the image. If the tournament organizer 70 selected a theme, the template for that theme would be the only one available. However, if the tournament organizer 70 did not select a theme, the templates from all themes will be displayed for the tournament organizer to select one. The brochure could contain the following information: contact information, tournament logo, tournament start date, tournament end date, tournament format, tournament description, course description, course photo, charity or corporate web site link, registration open date, and registration description. Furthermore, the tournament organizer 70 could also have the option to deselect and not include specified pieces of information.

The tournament organizer 70 could view and approve the brochure online. The brochure could be available in a PDF to download and print on the fly. The tournament organizer 70 could select to print the brochure online, or use a printing partner/affiliate for printing, including data submission/format to the partner site. Alternatively, the tournament organizer 70 could have the option to include the list of mailing and/or email addresses for printing and distribution of brochures via snail mail or email.

The tournament organizer 70 could also have the option in the marketing management module to use email templates. Emails could be system or custom generated. Templates for emails can be associated with the theme that was selected during event set up. If the tournament organizer 70 did not select a theme, then email templates from all the themes would be available for selection. Once emails are selected, the tournament organizer 70 would be presented with instructions for modifying the template and copy of the emails. Additionally, templates are provided for tournament organizers 70 to use for Sponsor Solicitation. A editable cover letter would be displayed with suggested copy within it.

The second page of the template based sponsor solicitation letter could contain information about the event and the sponsorship opportunities available. In some embodiments, the second page can be a PDF file that is not editable by the tournament organizer 70, however the second page pulls its information from the application based on answers to questions in previous modules.

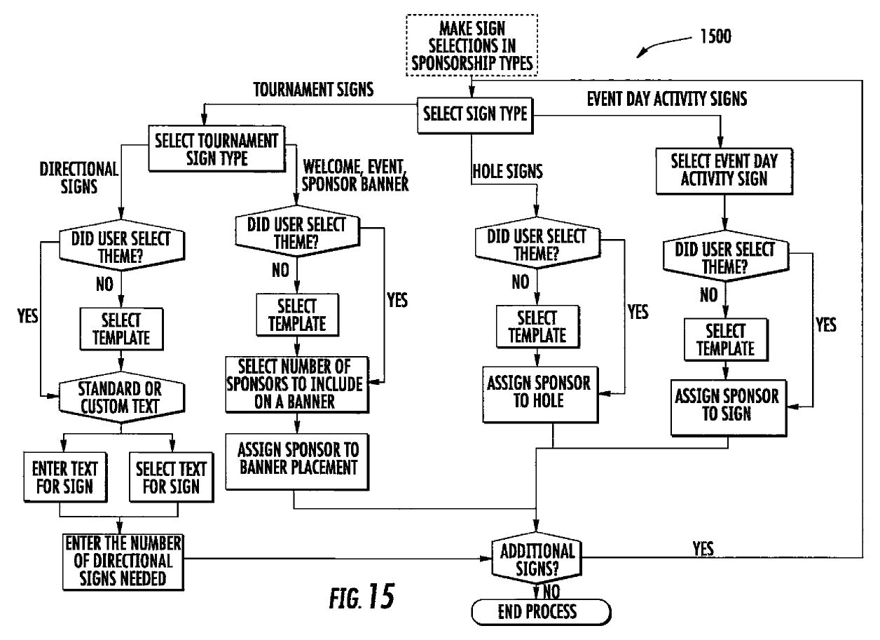

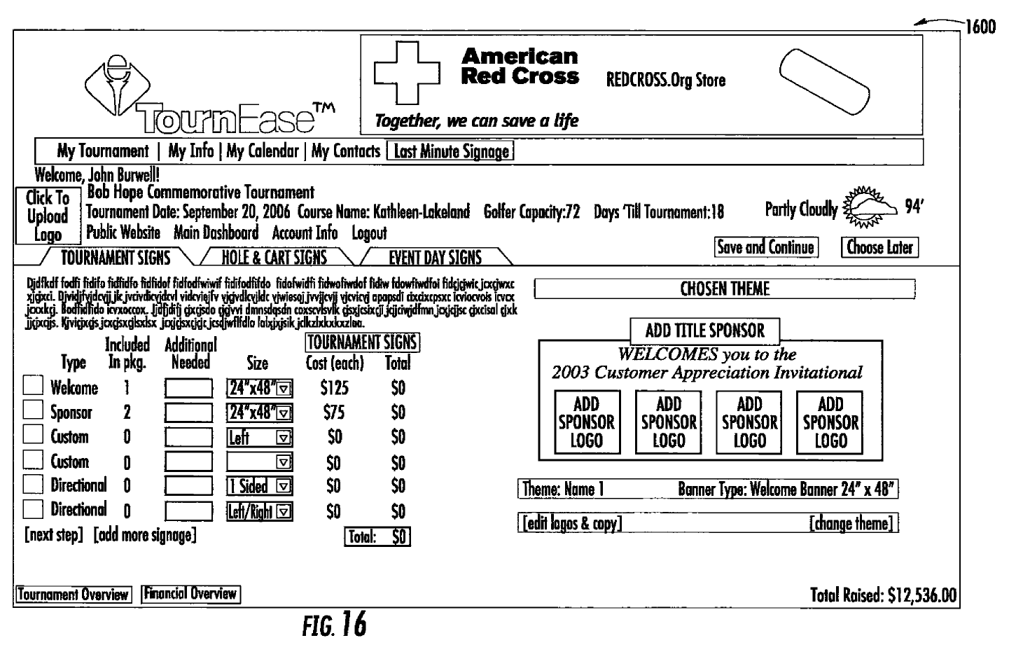

Also linked to the advertising module, the sponsorship module, and the venue module (to be discussed later) is a signage module that provides signs and banner options for the tournament organizer 70, as shown in process 1500 of FIG. 15. In the illustrated embodiment, the signs and banners interface of the signage module provides for planning and creation of: tournament signs, such as welcome banners, event banners, sponsor banners, and directional signs, hole signs, and event day activity signs, as shown in FIG. 15 and the exemplary screenshot 1600 in FIG. 16. System 5 also allows for online proof reading of any signage, which can save a great deal of time in the event planning process.

Themes can also drive the templates of all signs and banners. If a tournament organizer 70 has selected a theme during event planning, the template that is associated to theme will display for the sign or banner. If the tournament organizer 70 did not select a theme, they can select a template from any of the themes. If the tournament organizer 70 did not pick a theme and they select a template for any sign or banner option, the next sign or banner they create will be defaulted to the same theme template selected for the previous sign or banner.

The signs and banners interface of the signage module could also display the cost associated with each sign/banner option, and maintain a constant running total of the sum of the costs associated with the tournament organizer's selections. Items that are included as part of a package are highlighted as “included in package—no charge” The illustrated embodiment also provides that at X number of days before a tournament the tournament organizer 70 sees a button labeled “Add Last Minute Signs” that will enable them to select and purchase additional signs for the tournament.

The list of available sponsors to select from for placement on a sign or banner can be restricted to those that have sponsored in categories that qualify them for the particular sign/banner. For example, the hole sign placement screen will only display sponsors that have sponsored at a sponsorship level that includes a hole sign, or those that have sponsored a hole exclusively. Additionally, the list of available sponsors to select from for placement on a sign or banner can be categorized by their sponsorship type. In the illustrated embodiment, some sponsorship levels would qualify a logo for certain positions or sizes on a sign/banner, while others may not.

A standard “no logo yet” image can be provided for sponsors who have not provided a logo, but intend to. The holes that have sponsors with a “no logo yet” image will be flagged in order to alert the tournament organizer 70 at the specified time frame to go get the logo from the sponsor. Optionally, a sponsor can elect to supply text only instead of a logo, in which case the text will be displayed on the sign/banner.

In the illustrated embodiment the signs and banners interface can also provide the tournament organizer 70 with the ability to select from options that determine the number of sponsor logos on each banner. For each banner template, there could be multiple versions, each supporting a different number of sponsor logos. The minimum number of banners needed would then be defaulted to the number of banner spots allocated through the sponsorship types process divided by the number of logos per banner. For example, if 6 Title Sponsor slots are available, and each includes a logo on the event banner, then: the 2 logos per banner option would result in 3 total banners, the 3 logos per banner option would result in 2 total banners, and so forth.

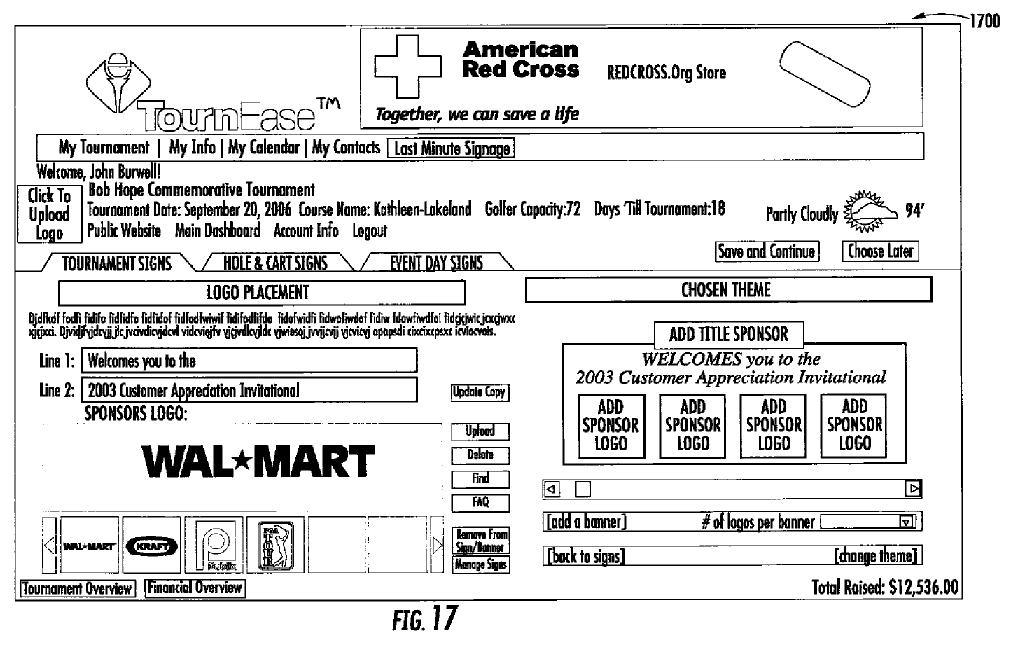

As shown in the exemplary screenshot 1700 in FIG. 17, the tournament organizer 70 could have the ability to drag sponsor logos from the right side of the page onto the banner images themselves. Logos would not be automatically removed from the logo list when placed on a banner; they can be reused on additional banners if desired. Additionally, the tournament organizer 70 would have the ability to specify the number of copies of each specific banner that will be printed. For example, after placing Budweiser and Nike logos on a 2-logo welcome banner, the tournament organizer 70 may choose to have 4 of these particular banners printed. Finally, the tournament organizer 70 may edit the copy (text) of the banners.

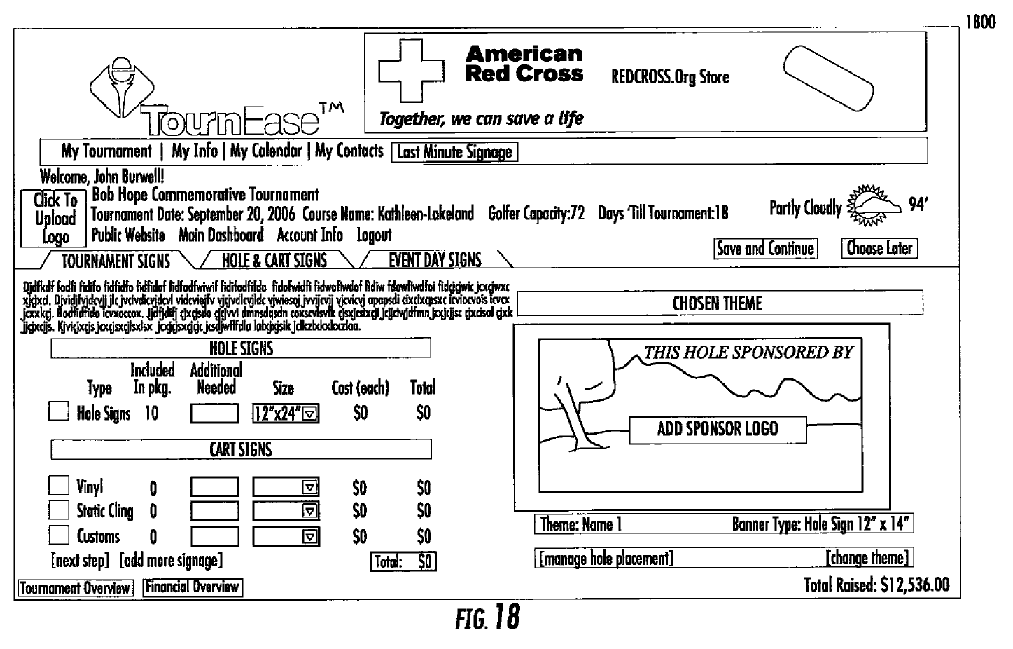

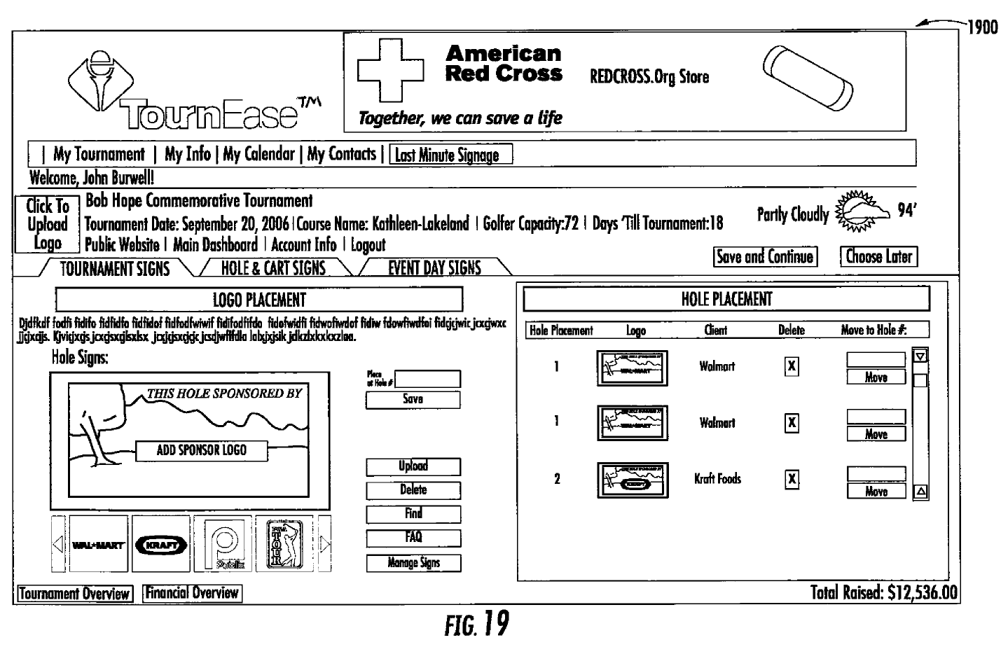

Hole signs could also be generated through the signs and banners interface, as shown in the exemplary screenshot 1800 in FIG. 18. The tournament organizer 70 could view and modify the theme selection for hole signs. Additionally, the number of holes to be assigned a sign will be equal to the number of holes committed through sponsorships, but tournament organizers 70 could add additional hole signs as needed. The hole assignment interface 1900, as shown in FIG. 19, would consist of one or more columns listing the holes being played in the tournament. The illustrated embodiment of the system would divide the number of holes sponsored by the number of holes in the tournament and round up to the nearest whole number to determine the number of columns to display. For example, if 40 hole sponsorships have been established for an 18 hole tournament, then there would be 3 columns of holes (40/18=2.22, rounded up to 3). Each column will be a complete list of all holes, even if the total exceeds the number of holes sponsored. This would allow the tournament organizer 70 complete flexibility to put the hole signs in any configuration desired. For example, for 40 hole sponsorships, 54 actual hole slots would be displayed so that the tournament organizer 70 could spread the 40 signs in any configuration. The interface could also allow for multiple signs to be placed on a single hole, constrained by the number of columns.

The interface could provide for the sponsor logos/text to be listed along the right side of the screen, in order to be dragged onto the hole slots. However, the list of logos/text is driven directly by the sponsors that have provided hole sponsorship. As a logo is dragged onto a hole, it can be removed from the list of logos, thus preventing the tournament organizer 70 from adding more hole sponsors than have been established through hole sponsorship. When a logo is clicked, from either the logo list or the hole columns, the logo would be displayed on the sign template that was selected.

The signage management module could also be setup to plan directional signs consist of a graphical arrow with text on the stem. Tournament organizers 70 can be given a list of standard of text options to place on the arrows. Drag and drop would be utilized to place text on arrows. The tournament organizer 70 could have the option to type what they want to appear on the arrow. For each directional sign that is established, either through drag-n-drop or typing, the tournament organizer 70 will have the ability to specify the quantity to be ordered.

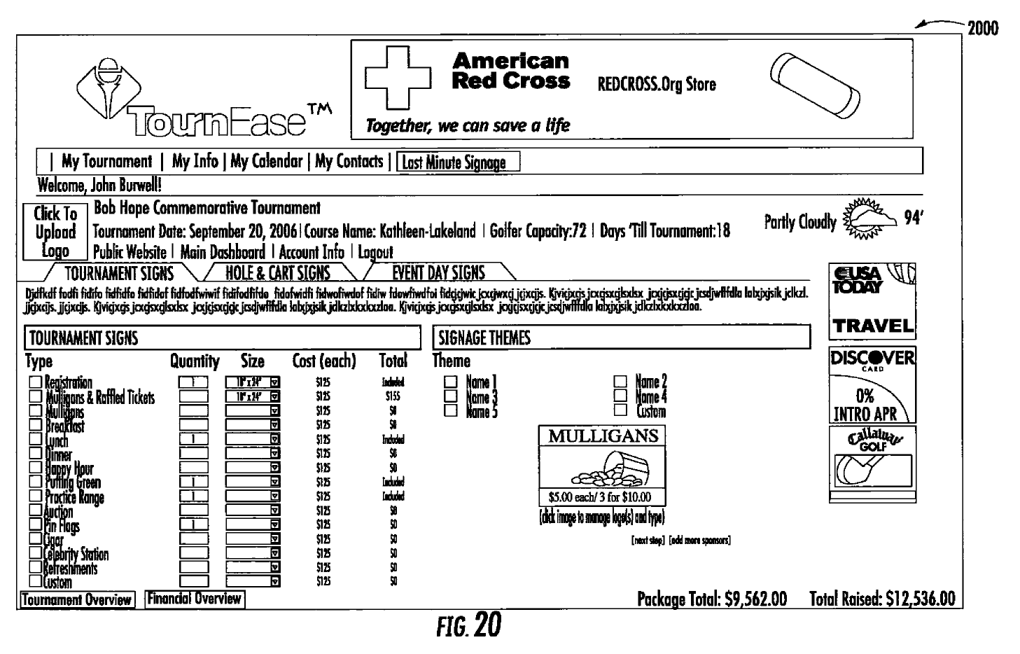

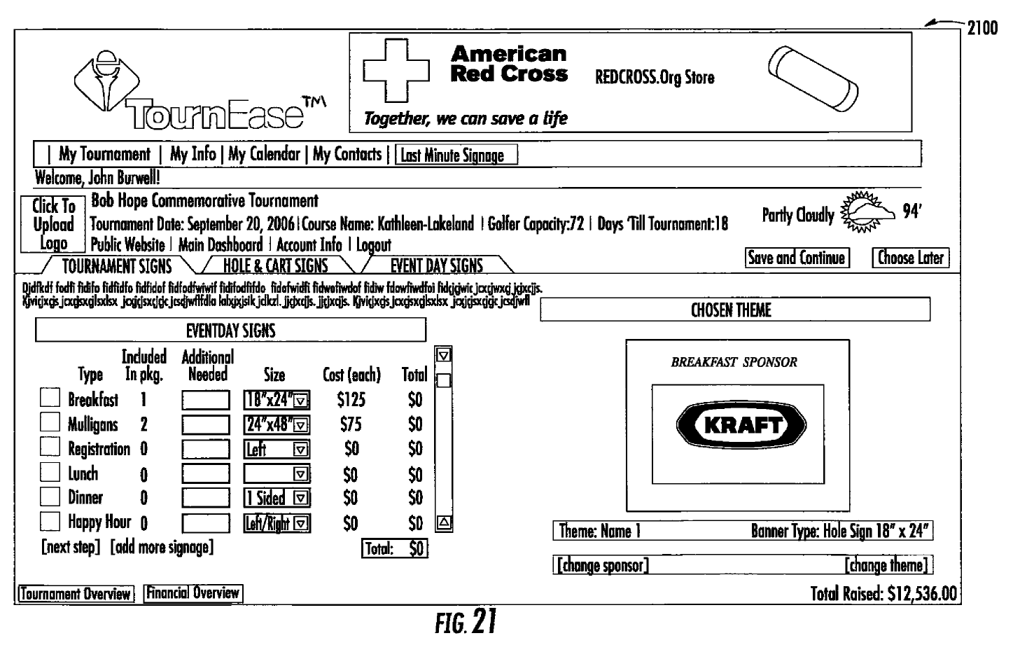

The Signage module also permits planning of event day signs, as shown in screenshot 2000 of FIG. 20 and screenshot 2100 of FIG. 21. Pre-selection of signs can be driven by options chosen in the event planning module 20, as well as sponsorship management module for specific activities. For example, if a putting contest is chosen during event planning, then a putting contest sign would automatically be selected. Furthermore, the tournament organizer 70 can specify additional quantities of the pre-selected items. The tournament organizer 70 can also specify additional signs not driven by event planning or sponsorship types selections.

Selecting a sign type displays the sign with sponsor logo, which was specified in sponsor management module, where appropriate. There may be multiple signs associated with a sponsors and the tournament organizer 70 could scroll to see all signs. If additional signs are ordered, a new sign appears with no logo and the tournament organizer 70 may choose “add logo” link beneath the new sign. This launches a logo placement interface similar to tournament signs interface. However, for banners and signs, or signs where there is no associated logo, sign text and quantity may be entered.

Finally, once signs are ordered and purchased, backend image process functionality would merge all images according to the tournament organizer's specifications. For example, the 3 sponsor logos specified by the tournament organizer 70 to be on the welcome banner are merged onto the welcome banner image. Additionally, a high resolution image could be generated from the merged images.

The system, as described in the illustrated embodiment, also comprises a venue management module that provides at least the following functionality: The addition of new courses, the updating of existing courses, and the deletion of existing courses. In the illustrated embodiment, courses may be initially loaded into the system via a manual batch import. For updating or deleting courses, the tournament organizer 70 may search for an existing record. Search fields could include: city/state, zip, course name, and contact (venue or course operator) name. Search results could include the course name, the address, and the contact name. Alternatively, the information can also include other types of services available from the course, including, but not limited to, products, apparel, instruction, and concessions.

However, for new courses after the initial load of courses by the venue management module, the module may require as an initial step that the information be entered manually. The module can attempt to match what is entered by the tournament organizer 70 to other records in the database and can suggest courses that may already be in the database to prevent duplicate entries. Information necessary can include course name, description, mailing address, primary phone number, physical street address, directions, internet address, course type, number of golf holes and types, course rating and difficulty, signature hole image or course image, course contacts, contact position or title, and contact picture. Alternatively, the information can also include other types of services available from the course, including, but not limited to, products, apparel, instruction, and concessions. New course information could be added by the tournament organizer 70 or the system manager 80. However, the course operator may be allowed to edit course information.

When a course is used for a tournament for the first time, the module sends an automated email to the course operator containing: an explanation of what the email is for, a link to the venue service access module, along with a brief description, and suggestions on what they should do within the module. The link may also contain an identifier that allows the course operator to create a password for the service access module. However, the course operator could be automatically granted access to the course information for which they are listed as the course operator.

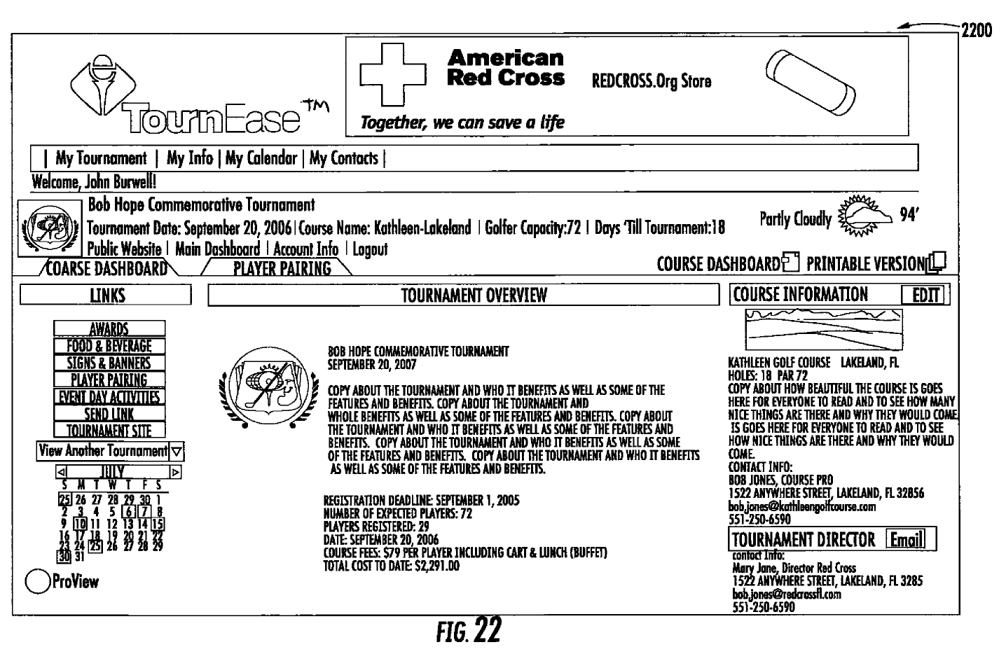

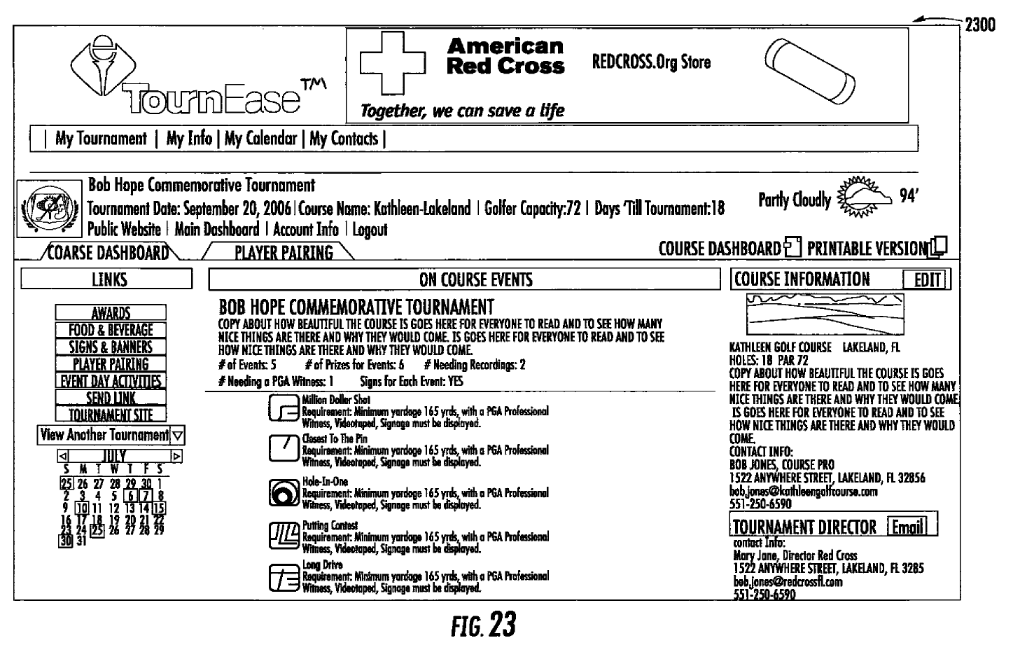

Additionally, the access module serves the personnel of the golf courses where tournaments are being planned, as shown in screenshot 2200 of FIG. 22 and screenshot 2300 of FIG. 23. For each tournament being planned at a course, the course operator can have access to summary views indicating basic tournament information such as: name, description, registration deadline, tournament date, format, number of expected participants, number of registered participants, course fees per participant, tournament organizer contact information, and other contact information as appropriate.

Course personnel also can have access to more detailed information via a menu providing the following: awards and format, food and beverage selections that have been made at the course, signs and banners, including lists of all tournament and event signage with locations, if known, participant pairing sheets generated by the organizer 70, special events, including locations, prizes, signs and requirements. Additionally, a tournament calendar may be provided indicating all tournaments currently being planned for the particular course and course operator may select another tournament to view or to provide alerts to course operators.

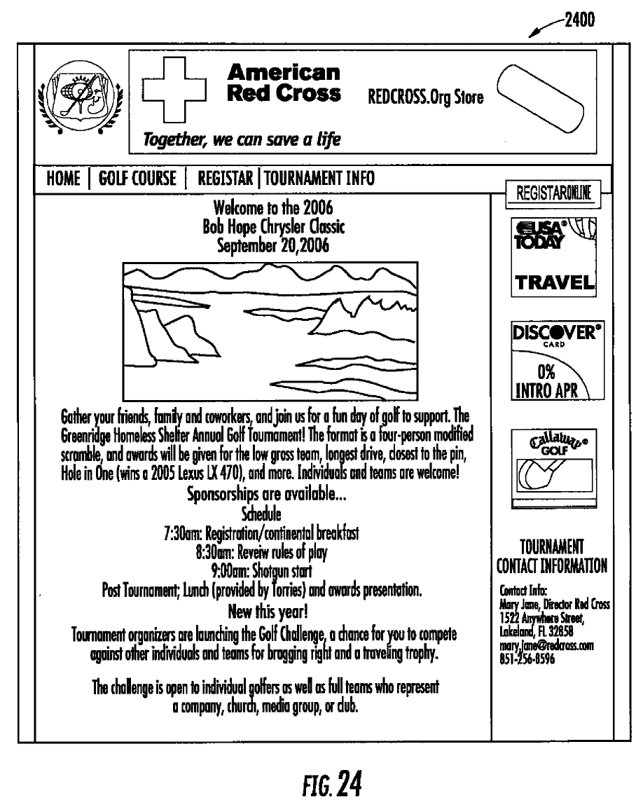

As previously discussed, the marketing management module controls the creation of websites and other participant interfaces for the planned event. However, since there is a need to also manage participant information, the illustrated embodiment provides a participant management module to manage and gather information regard participants and scheduling of participants in events. In some embodiments, tournament organizers 70 can enter information from participant registration forms received through regular mail, fax, or otherwise. However, since the marketing module provides the ability to create functional websites, as shown in FIG. 24-28, participants can self register through the websites, thus reducing possible errors and saving the organizer 70 time.

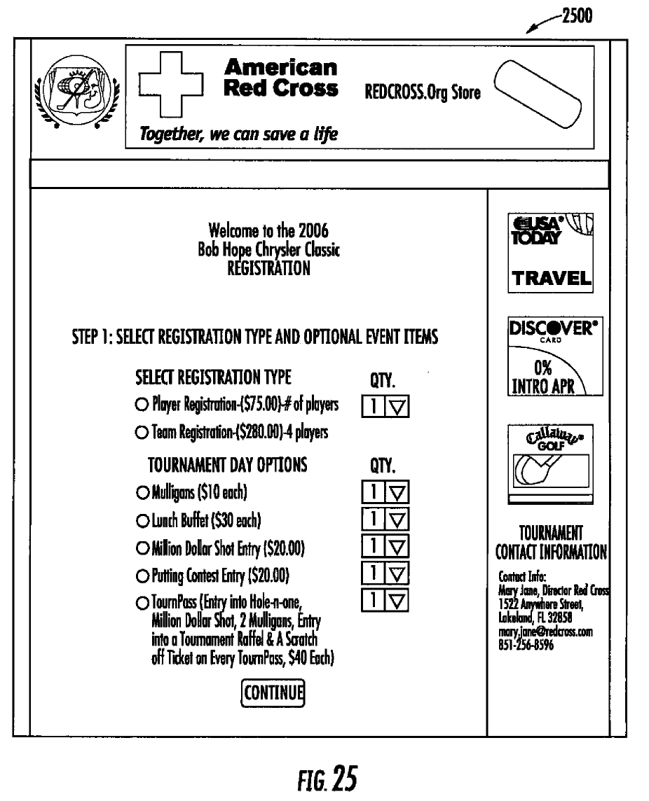

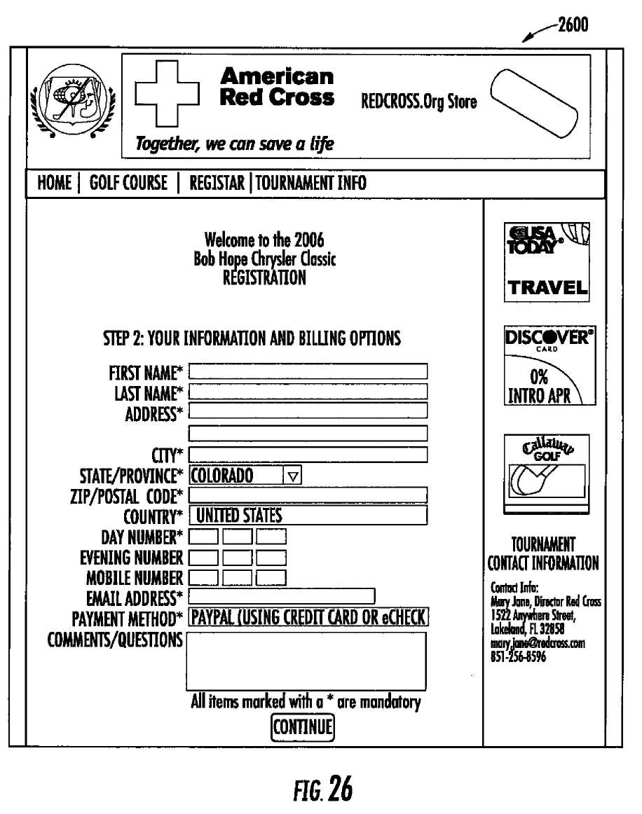

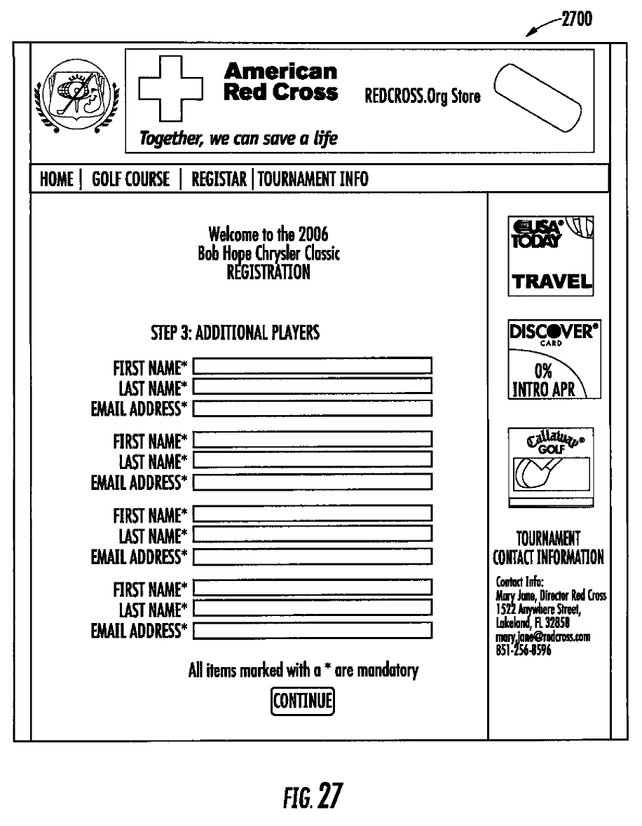

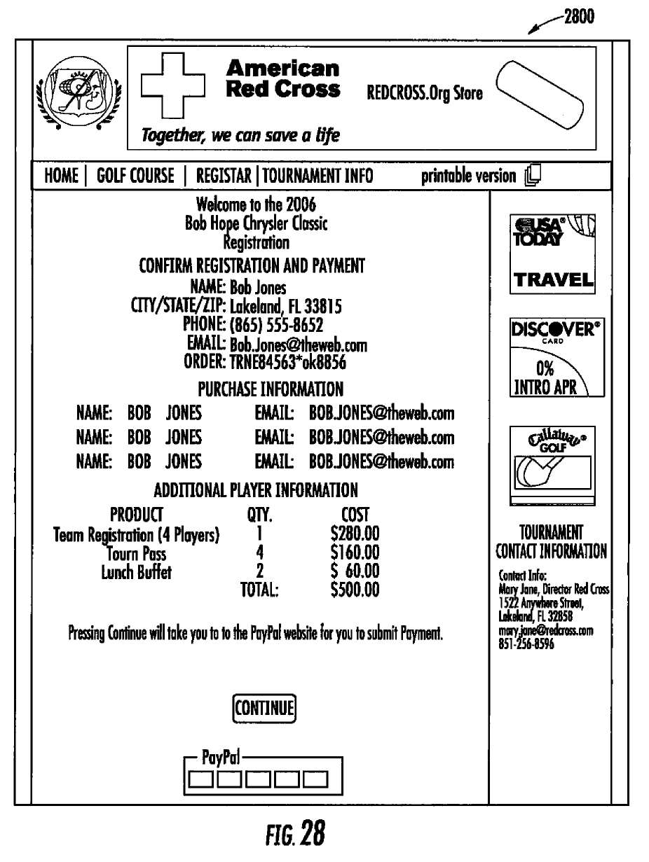

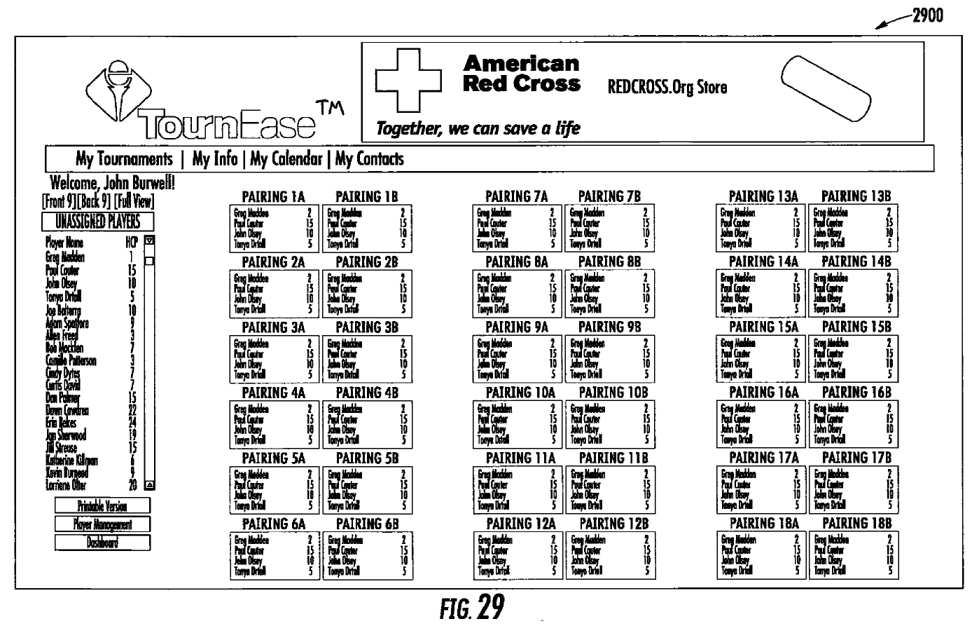

In the screenshots 2400 through 2800 of FIGS. 24-28, the participant arrives at the website and is given the option to register. As shown in FIG. 25, the participant would be prompted by the website to enter type of registration, a participant, multiple participants, or a team, and choose to participate in other special events. As shown in FIG. 26, participant could be asked for name, address, contact information, payment method, and other information. Additionally, when the participant has chosen multiple participants or a team, the website could prompt the participant for the additional participant information, as shown in FIG. 27. Ultimately, the information provided by the participant is processed by the participant module to confirm payment and registration, as shown in FIG. 28. Once the registration is complete, the information stored in the system management module 10 can then be used by the event management module 30 or the venue operator to create and publish pairs or other participant information, as shown in screenshot 2900 of FIG. 29.

In additional to basic registration functionality, the participant management module could also provide participants with the ability to customize pairing and teams, whether the participant is establishing a pairing (twosome or foursome), or registering alone, or joining an existing foursome. If the participant is establishing a pairing, the names of additional participants would be entered if known. However, whether the participant info is entered or not, the additional spots in the pairing could be allocated as “ghost” participants. The system could also provide for identifying the pairing in some way so that it can be referenced on subsequent registrations by participants to be added to the pairing. For online registration, a code could generated that can be entered by subsequent registrants to find the particular pairing. Additionally, the participant may send automated emails containing the code from the tournament website to other members of the pairing. However, where a participant is registering alone he could be added to the participant list, but no pairing is created. The participant would be paired at a later time by the tournament organizer 70 or the venue operator.

In the illustrated embodiment, a participant that is joining an existing pairing specifies information about the foursome that he/she is joining. For online registration, the participant may enter the code for the pairing, or enter some identifying information about the pairing (who established it, what company, etc.), but the participant could search pairings. For manual registration, the tournament organizer 70 could be provided with the ability to search for pairings by: any name associated with a pairing or the company associated with a pairing. Furthermore, as participants are added to pairings, the ghost records are removed. In some embodiments, the participant management module could allow for a mass upload of participant registrations via spreadsheets or other computerized form.

However, the module would not require all fields be completed before submitting registration. Tasks and alerts (to be discussed later) could be sent to the tournament organizer 70 to follow up on missing information on registrations forms. For example, if the participant provided an email address the tournament organizer 70 is given the option to contact the participant via email for the missing information. If no participant email address is provided, the tournament organizer 70 could call the participant to obtain the missing information. In either case a contact could be logged in the system to acknowledge that a request was made for the missing information. When participant registration reaches capacity, the module could allow participants to register online or by the tournament organizer 70 and place them on a wait list.

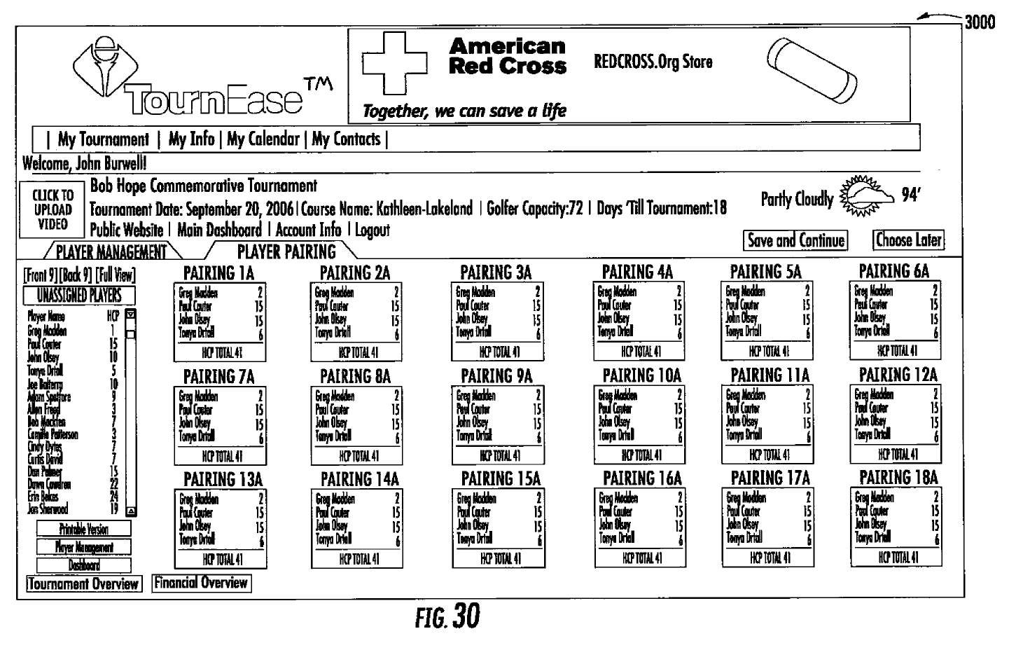

Online registrants may print out a receipt to be taken to course for check-in, and could be tracked by the participant management module. Once pairing is complete, the tournament organizer 70 can be provided with a graphical view of all pairings, as shown in screenshot 3000 of FIG. 30. A list of unassigned participants can also be provided so that the tournament organizer 70 can drag participants into pairings.

The participant module also provides flexibility in pairing by allowing fivesomes, dynamic changes in pairings, starting holes, and unlimited pairings per hole. The module then automatically assigns a hole assignment based on the order in which the pairing was placed on the hole. For example, the second pairing placed on a hole #5 will be 5B, the third will be 5C, etc.

As previously discussed the tournament organizer 70 can post the pairings sheet as shown in FIG. 29, to allow the venue operator to view, post this sheet to the tournament website, or can be printed for day-of-tournament so that walk-ups may be placed into pairings. Additionally, cart signs for assigning carts to pairs can be printed from this module.

In one embodiment, system 5 allows for pairings to be moved as one unit. For example, if an unassigned player is selected, such as via a drag and drop on the display onto hole 11, then the three others in his foursome or other pairing will move with him or her into that slot. This pairing or group manipulation expedites any interface with system 5 rather than requiring each of the team or pairing members to be selected.

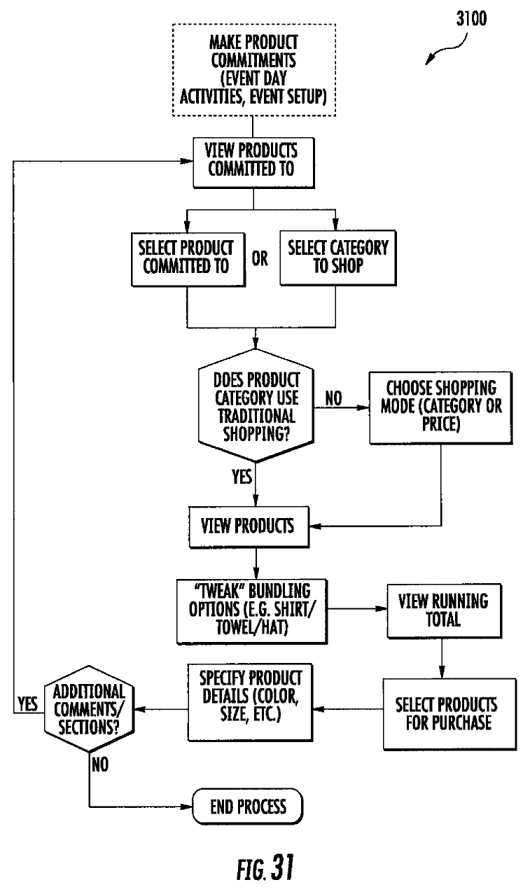

As previously discussed, the illustrated embodiment also includes a product or merchandising management module, which can be accessed during the use of the event planning module 20 or directly by the organizer 70, as shown in process 3100 of FIG. 31. The product module could include, but is not limited, the following options: apparel, golf balls, accessories, hats, towels, snacks and food, awards and trophies, and prizes and gift cards. For all merchandise decorated with a logo, the module can allow the organizer 70 to specify the number of logos that will appear on that piece of merchandise in order to see the pricing impact. Logo placement on the merchandise will happen by linking with the logo management module or as part of the logo management module.

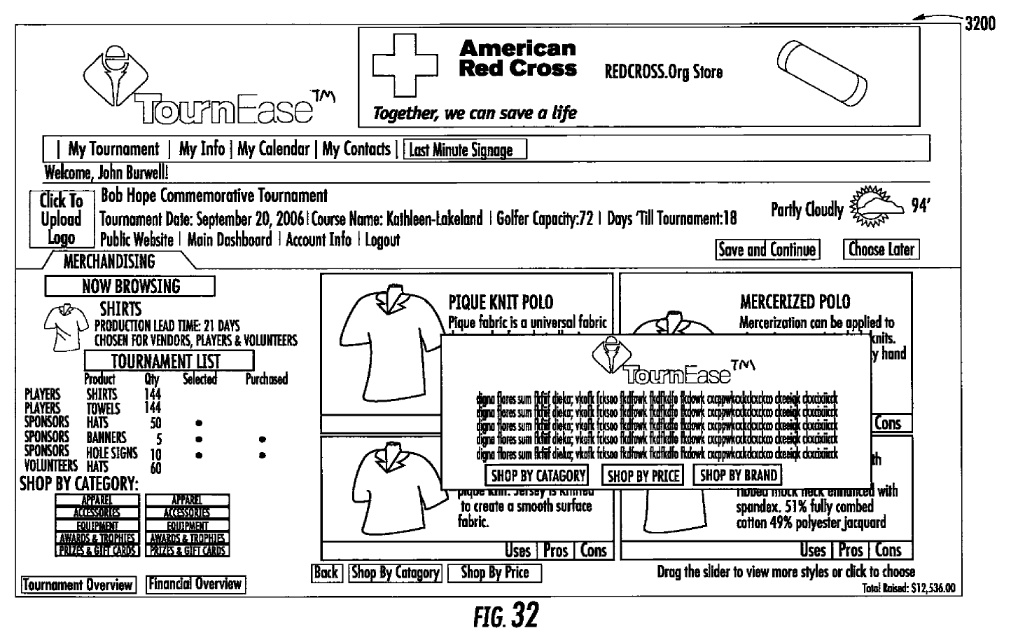

For all merchandising options, as shown in the screenshot 3200 in FIG. 32, there can be a place on the products management module interface which lets the tournament organizer 70 know the number of items they have already committed to, which have been selected, and which have been purchased. For all merchandising options, the tournament organizer 70 could be allowed to specify in the product management module, rather than selecting a product, that an item is one of the following, thereby satisfying the commitment: tournament provided, course provided, none to be provided.

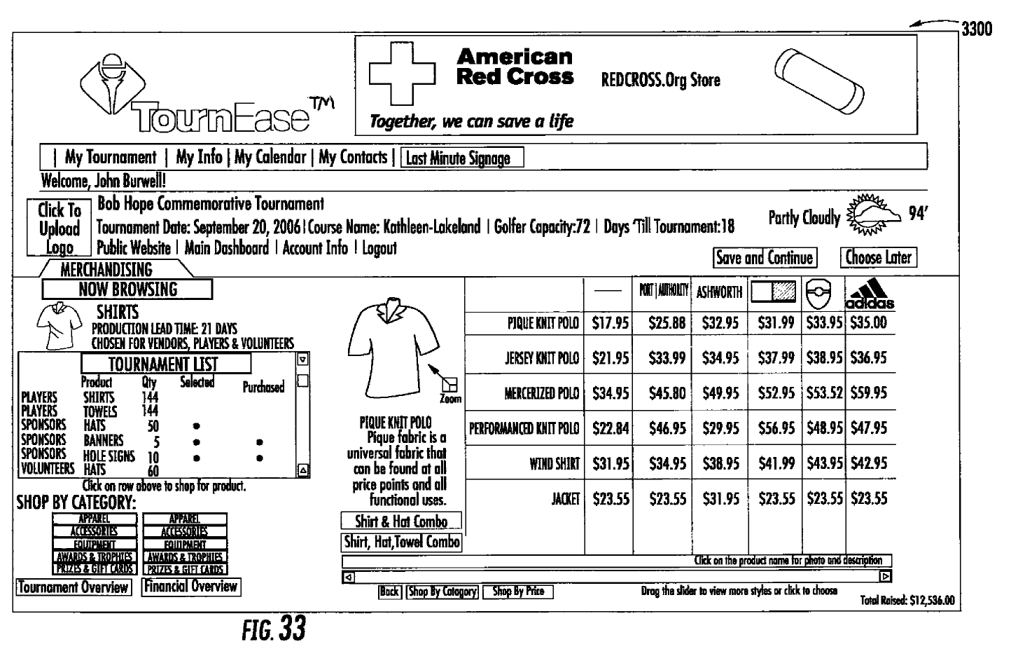

Shopping for apparel, hats, or golf balls utilizes a “matrix” interface, as shown in the screenshot 3300 in FIG. 33. Tournament organizers 70 can be prompted to shop by price or category. Shopping by price prompts the tournament organizer 70 for a price range, and then displays a matrix of items with categories along the side, and brands across the top, as shown in FIG. 33. Categories and brands are driven by product catalog specifications. Options that do not fall into the price range selected can be grayed out. The tournament organizer 70 can also have the option to apply bundles. For example, if shirts are being viewed, the tournament organizer 70 may select to view the pricing for a bundle including shirts, hats, and towels. Option selections can be visually displayed. For example, a standard image of a sleeve vs. a dozen golf balls. The tournament organizer 70 may also be allowed “tweak” the price range to see additional options.

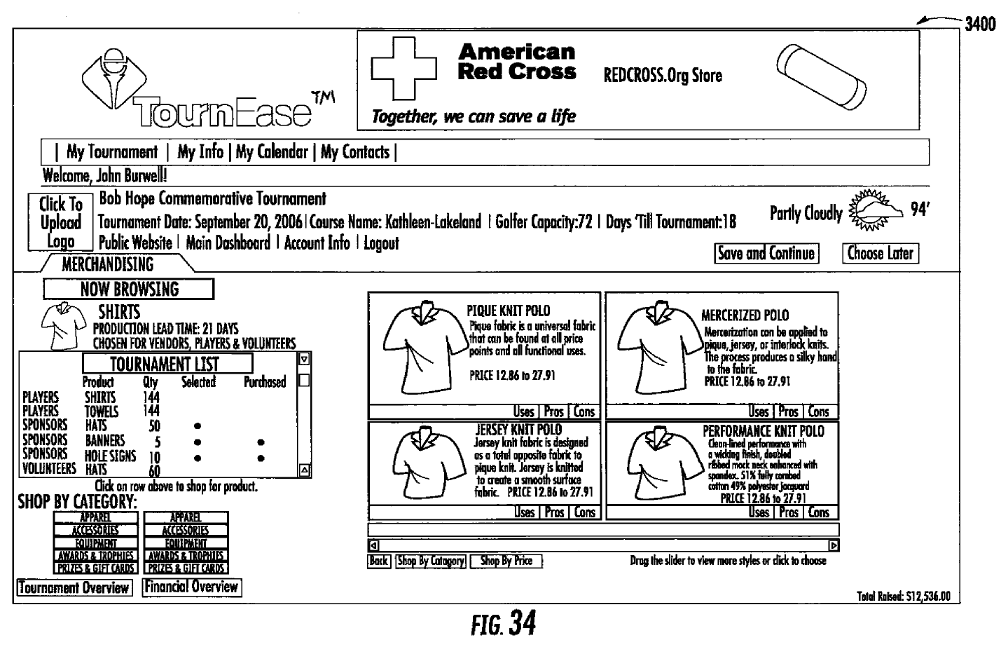

Shopping by category results in a view showing a detailed description of each product category, as shown by the screenshot 3400 in FIG. 34. Detailed category info can include: description, price range, uses, and reviews.

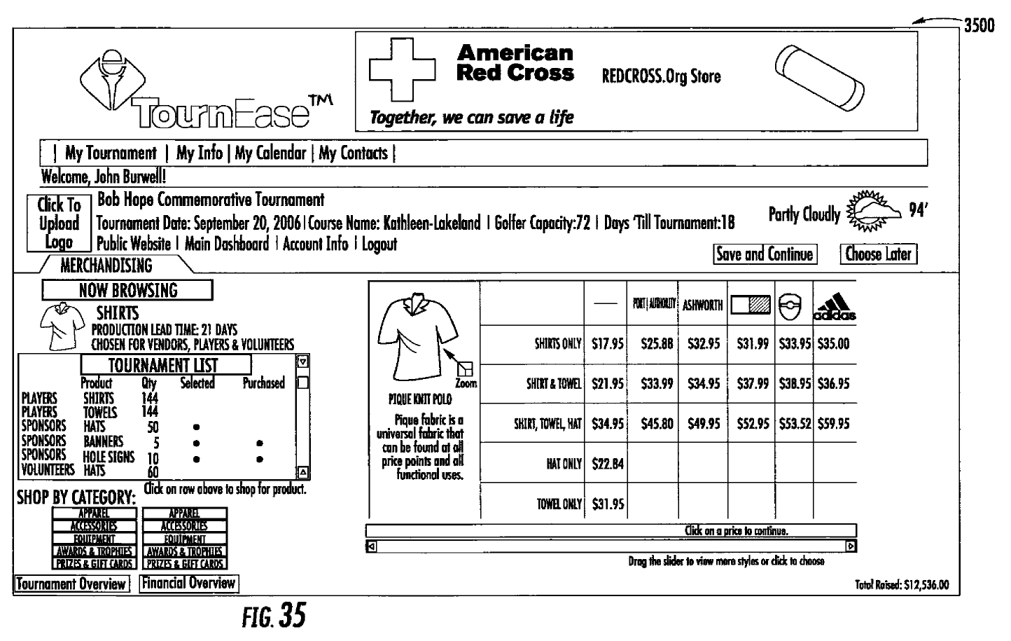

Selecting a category results can also use a matrix view, but with slightly different characteristics than the matrix view defined above, as shown in screenshot 3500 in FIG. 35. Rather than categories down the side of the matrix, bundle options can be displayed, e.g. shirt, shirt/hat, shirt/hat/towel.

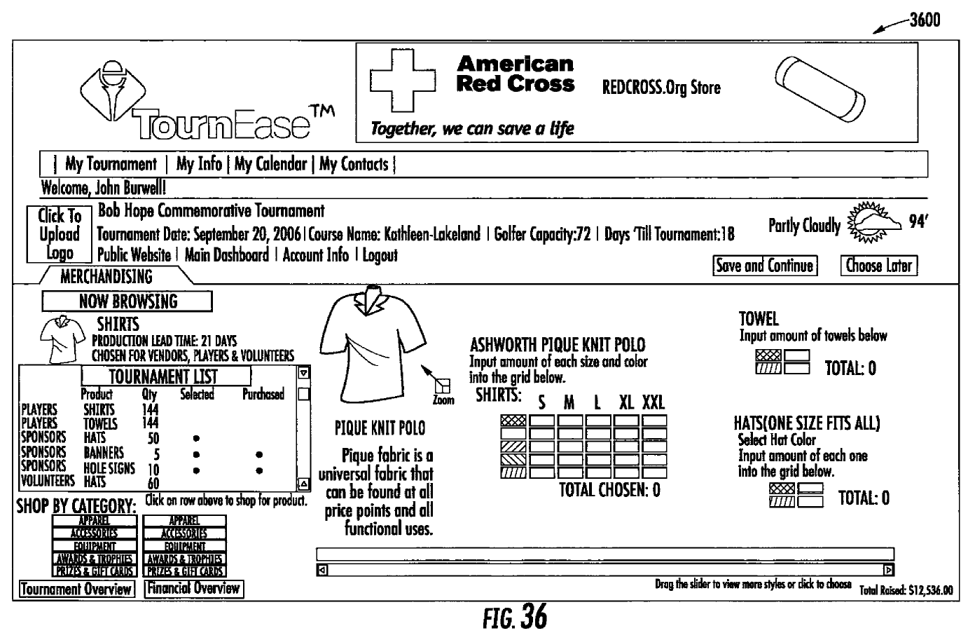

For all products, the tournament organizer 70 can be allowed to select the number of logos that will be placed on an item in order to see the pricing impact. Each product category label employs hover-over-popup behavior to display a description of the style. Alternatively, in all matrix interfaces, clicking a pricing option in the matrix navigates the tournament organizer 70 to a confirmation page where additional product details are selected, such as colors, sizes, and so forth, depending on what is specified in product management module, as shown in screenshot 3600 in FIG. 36. Field definitions of these additional details are based on how the product is configured.

The product management module could also allow tournament organizers 70 to shop for accessories, towels, snacks, awards, and prizes via a traditional shopping cart experience. There would be a hierarchy of categories and as the tournament organizer 70 selects a category the products within that category are displayed. The tournament organizer 70 could also sort the results by price or category. Additionally, only products specific to each shopping purpose might be displayed. For example, when shopping for awards, only those items that have been flagged as “available for awards” in the product management module are displayed.

For awards and contests, the tournament organizer 70 could have the ability to specify the award/contest for which each item is being chosen by dragging the item onto a slot that represents the award/contest prize. Award and contest slots are driven by choices made in the event planning module 20 and selected Event Day Activities. However, in some embodiments prizes might be predetermined. For example, hole-in-one prizes may not be chosen in the products interface, instead they may be chosen during event planning when the hole-in-one option is chosen.

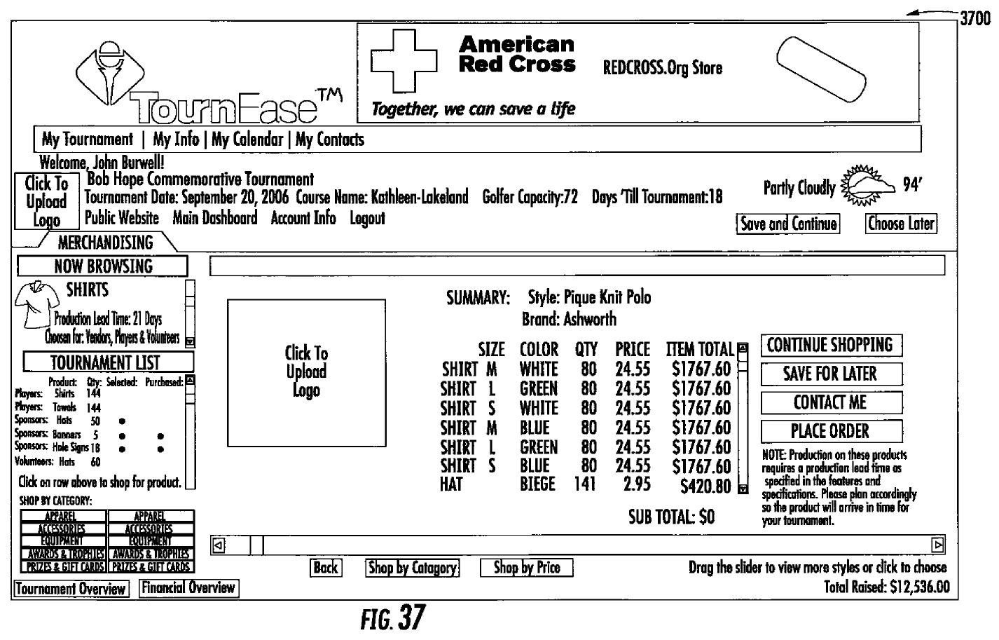

As shown in FIG. 37, a financial summary can be displayed at the bottom of the screenshot 3700 indicating: the total amount for all selected items and the budgeted amount (if specified previously). Regardless of shopping experience or selections, an order summary could be displayed indicating all selections.

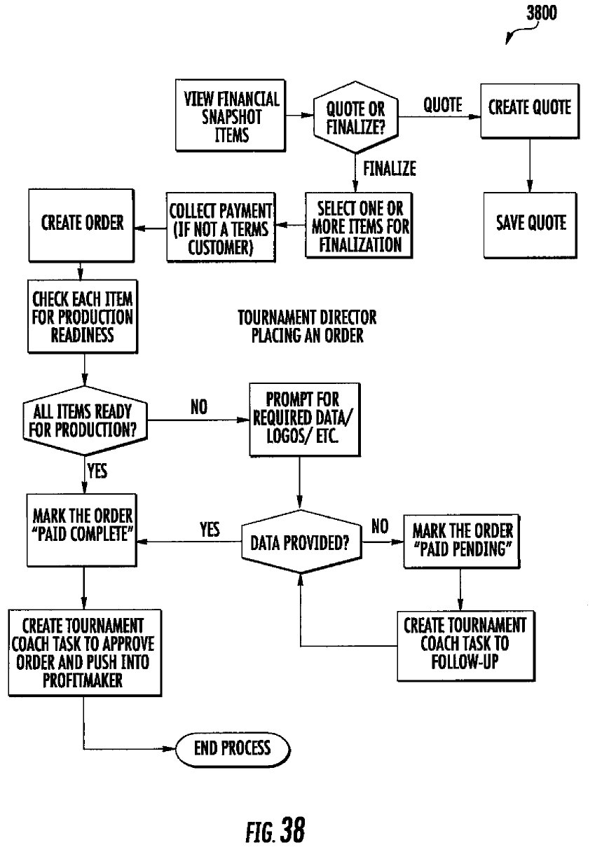

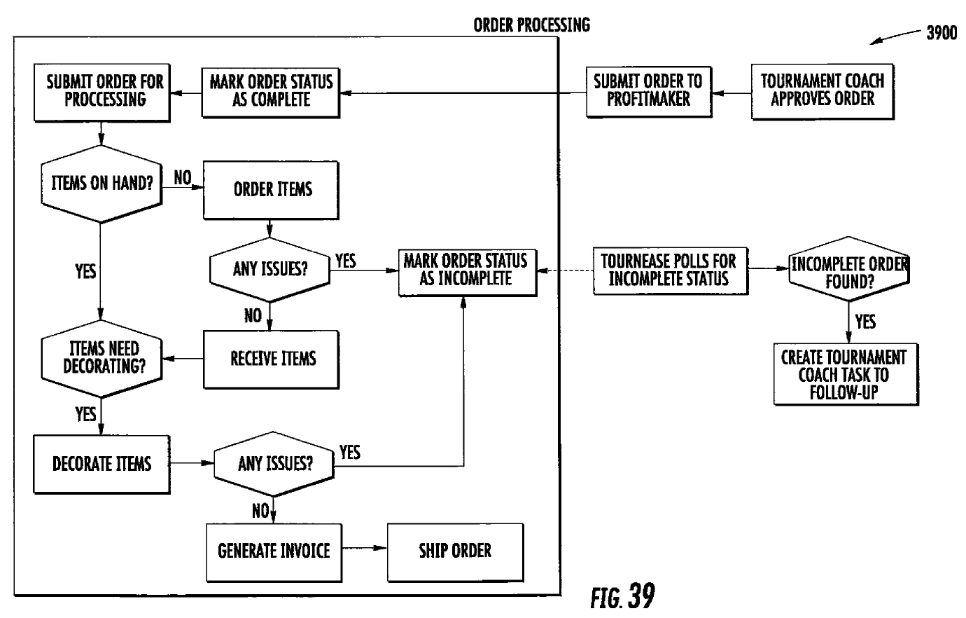

In conjunction with the products, venue, and signage management modules, a back end module could also be provided to have ordering and payment of goods and services required for the tournament. In the embodiment illustrated, a module would operate using a process flow 3800 as shown in FIG. 38 or process flow 3900 as shown in FIG. 39, using order and supply techniques well-known in the art.

The main supervisory module for the tournament organizer 70 is through the interface of the event management module 30. In the illustrated invention, the event management module 30 tasks can comprise major monitoring and management of areas, including, but not limited to: task and alerts, finances and budgets, participants, sponsors, products and merchandising, and logos.

In the illustrated embodiment, tasks and alerts may be created based on predetermined alerts configured during event planning. However, the tournament organizer 70 has the ability to add additional custom tasks with a popup form, by including the following: task name, comments, module to link to, due date, reminder date increment, and reminder date measure. Clicking a task navigates the tournament organizer 70 to the module associated with the task. Module associations are created as part of a tournament timeline or custom task creation. In such embodiments, tasks can be ordered by due date descending. Overdue tasks could be highlighted in red or some conspicuous color or other marking. Similarly, tasks due within 7 days may be highlighted in yellow.

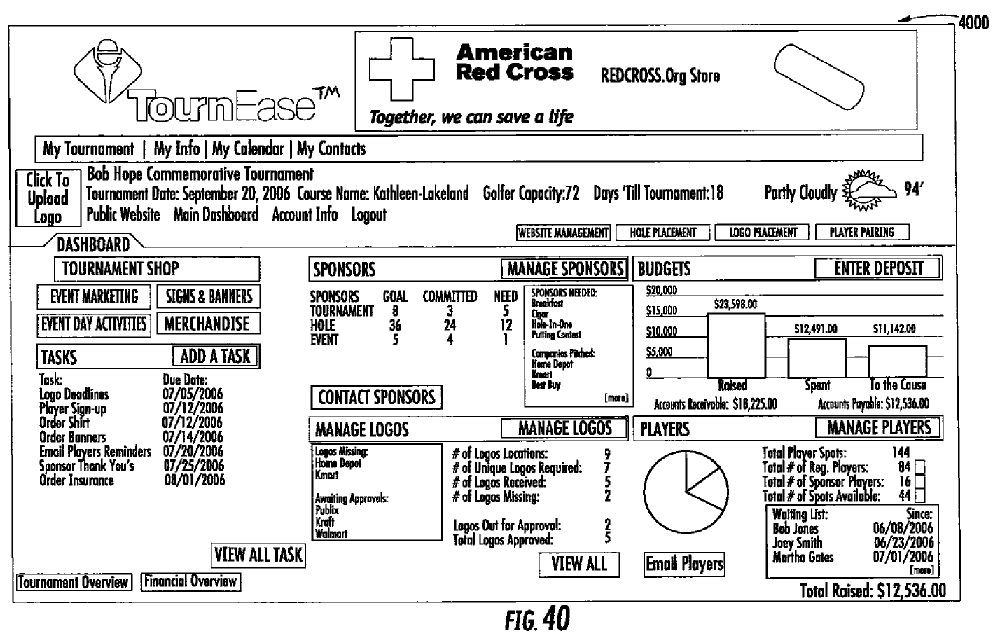

Finances information, as show in screenshot 4000 of FIG. 40, can include a graph indicating revenue, expenses, and profits. In the illustrated embodiment, clicking any part of the graph navigates the tournament organizer 70 to the financial management module (to be discussed later). The event management module interface could also include an “accounts receivable” line with the amount that is currently owed from sponsors (committed but not collected). Similarly, the information could include an “Accounts Payable” line with the amount that has been committed to for purchases, but not yet paid.

Participant information, as shown in FIG. 40, can include a graph showing the number of participants registered relative to the expected number of participants. As shown in the illustrated embodiment, the graph could indicate spots that have been held for sponsors. Similar to the finances information display, clicking the participant table navigates the tournament organizer 70 to the participant management module. Additionally, a list of wait listed participants could be displayed.

Sponsor information, as shown in FIG. 40, can include a table indicating a listing of open sponsorship opportunities available and the total number of sponsorship opportunities by type.

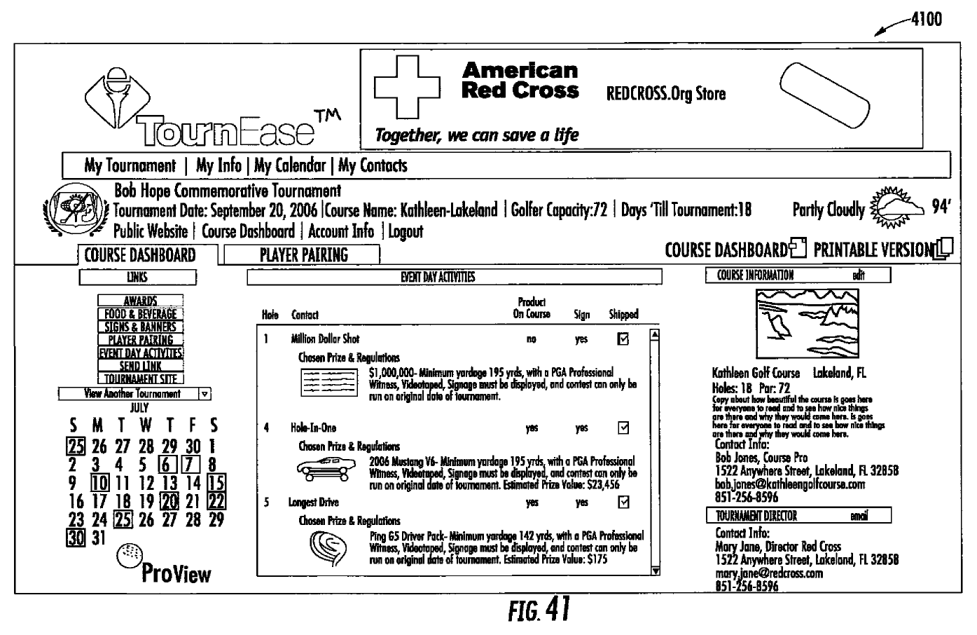

Products information, as show in screenshot 4100 of FIG. 41, can be linked via the event management module 30 to the marketing management module, the event data, and the signage management module. In the various embodiments, the organizer 70 can monitor and adjust product availability and ordering by being linked to the products management module.

Logo information, as shown in FIG. 40, consists of a table indicating: number of unique sponsor logo locations, unique logos required, logos received, missing logos, logos out for approval, total logos approved, and number of sponsors with logos. In the illustrated embodiment, a link that navigates the tournament organizer 70 to the logo management module can be provided.

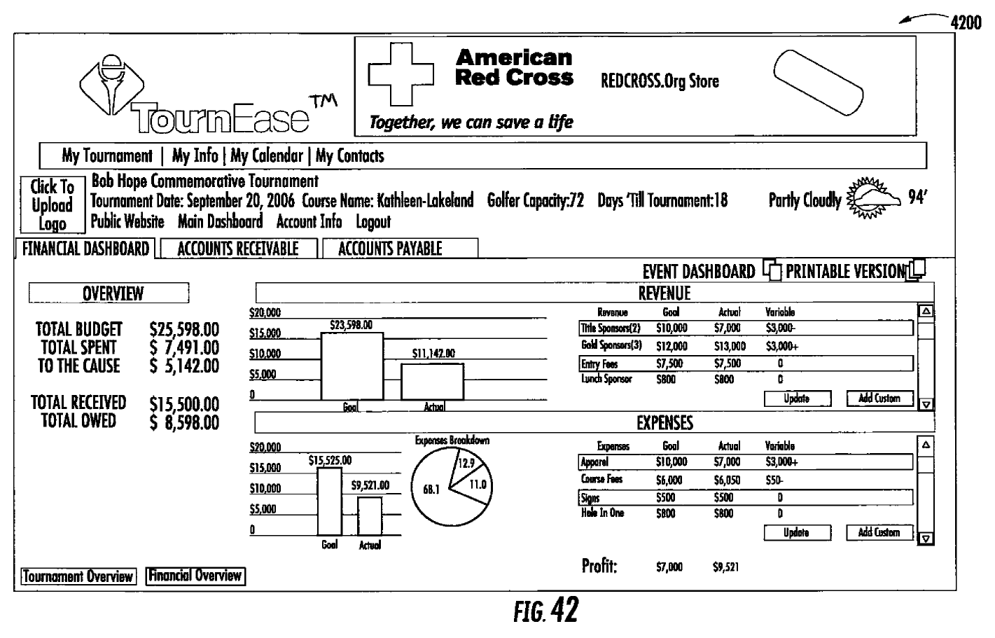

The financial management module consists of the following major features: a financial interface, accounts payable, and accounts receivable, as shown in screenshot 4200 of FIG. 42. The financial interface provides a complete view of all tournament finances, including: financial overviews, revenue summary, expenses and profits. In the illustrated embodiment, the financial overview includes budgeted revenue and expenses and actual expenses, revenues, and profits. The revenue summary can consist of a graph indicating goal vs. actual revenue. Furthermore, the summary may have a listing of revenue by type, including specific sponsorships, with an indication of the number of opportunities within each type. This list can be driven by selections in the sponsorship management module. Revenues can also include participant registrations, goals, variances, or other customized metrics. The expenses summary can include a graph indicating goal vs. actual expenses. More particularly the graph can indicate the breakdown of actual expenses by type, including apparel, course fees, signs, and other expenses. As shown in the illustrated embodiment, profit numbers can appear below the revenue and expense sections for both the goal and actual columns. In the various embodiments, the fields available in the financial module could be customized to include any type of information or other type of expenses or revenues.

The finance management module interface can further include an accounts payable tab that allows the tournament organizer 70 to enter actual expense payments. In the illustrated embodiment each expense item includes the following fields: to (payee), date paid (if any), for (purpose/description), memo, payment type, and amount. Icons can also be provided to indicate: pending, invoiced, but not paid, and invoiced and paid.

Checkboxes can exist for multiple selection of items, so that payments can be recorded that cover multiple sponsor commitments with a single check. In the illustrated embodiment buttons allow the tournament organizer 70 to do the following: add a payment, modify an existing entry, delete an entry, or find a record. A search box could also be provided to allow the tournament organizer 70 to enter search text for the following fields: payee, description, or amount. A “total paid” total can be displayed at the bottom of the screen.

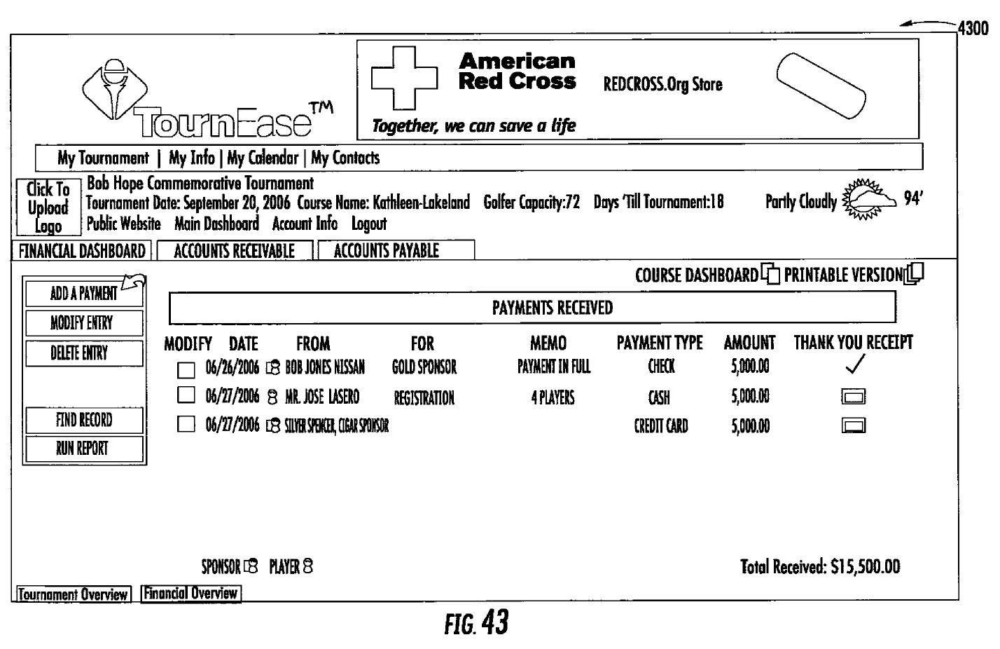

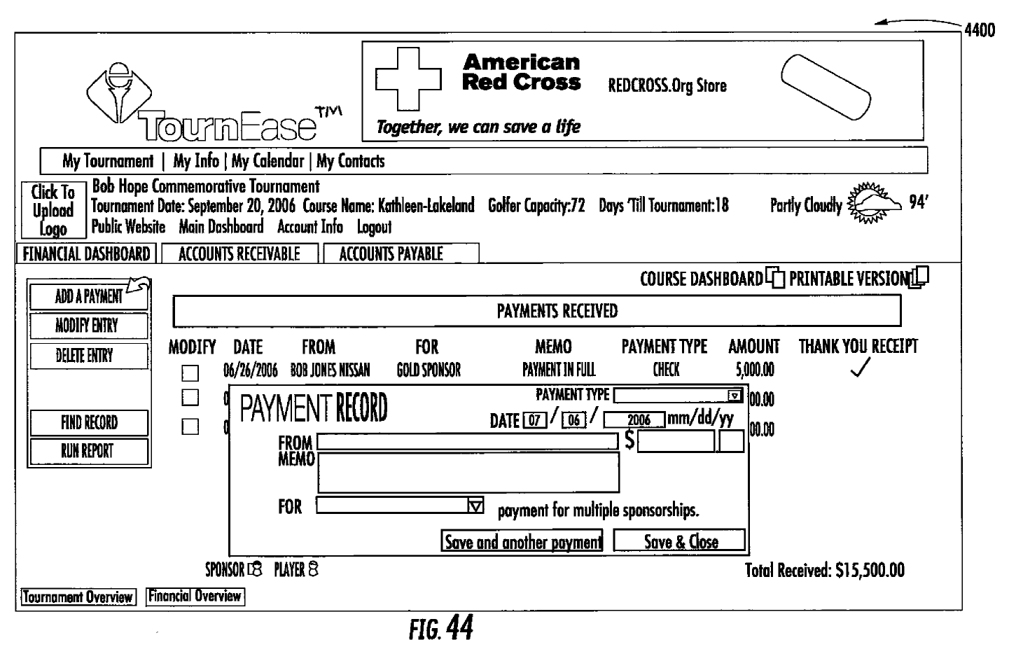

In the illustrated embodiment, as shown in screenshot 4300 of FIG. 43 and screenshot 4400 of FIG. 44, the accounts receivable tab allows the tournament organizer 70 to enter actual payments received. Revenue items from the following sources can be displayed: sponsorships, from each sponsor commitment or participant registrations. Each revenue item can include the following fields: from (payer), date paid (if any), for (purpose/description), memo, payment type, and amount. An icon allowing the tournament organizer 70 to issue a receipt and thank you email to the payer and to show status can be provided. Checkboxes can also be provided for multiple selections of items, so that payments can be recorded that cover multiple sponsor commitments with a single check. Buttons can also be provided to allow the tournament organizer 70 to do the following: add a payment, modify an existing entry, delete an entry, or find a record. A search box can also be provided, allowing the tournament organizer 70 to enter search text for the following fields: payer, description, and amount.

It will be appreciated that, by providing a modular system, certain modules may be omitted for the organization of certain events. For example, if no products are to be produced along with the event, the organizer 70 may choose not to use the product management module, etc. Additionally, while screenshots and other information has been given in relation to a golf tournament, it will be appreciated that the information may be altered depending on the type of event that is being organized.

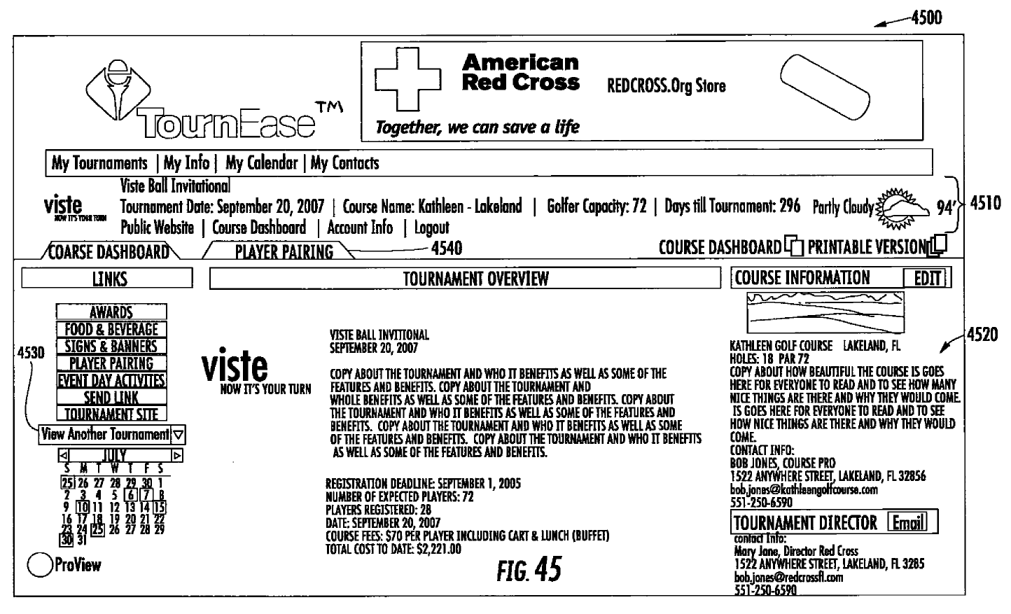

Referring to screenshots 4500 through 5600 of FIGS. 45 through 56, another exemplary embodiment of event planning system 5 is shown. System 5 can have many of the features and processes described above with respect to the embodiment of FIGS. 1 through 44, including modules 10, 20, 30 and 40. In screenshot 4500, tournament details 4510 can be presented including dates, capacity and weather for a particular tournament. In one embodiment, the weather information can be a live weather feed for any of the venues, e.g., golf courses, that have been or may be selected as a site for the event. An information overview 4520 for the tournament can be shown which includes registration information for players, as well as course information and contact information. The tournament details 4510 and overview 4520 can be publicly accessible, which allows review and registration through the system 5. In one embodiment, a user can register using system 5 and have the registration funds directly deposited into the event account. In one embodiment, a tournament organizer 70 has real-time or substantially real time updates to the tournament information including real time updates to the players registered and the event account. A user can access information for multiple tournaments, such as through drop-down menu 4530. A user can access the player pairings for the tournament at menu 4540.

In screenshot 4600, a user can select on-course contests from contest menu 4610. In one embodiment, system 5 coordinates the providing of insurance for contests to the user, such as through a third party insurer, the price of which is based upon the type of prize and number of players. This insurance can be ordered online through system 5 to expedite the planning of the event.

In screenshot 4700, the user can select sponsors for each of the holes in menu 4710. The user can customize the sponsorship of the holes through use of logo placement menu 4720. In one embodiment, a user can select a logo from a logo library or database, such as by dragging and dropping the logo on to a sign. The sign and logo will then by positioned at the selected hole prior to the event.

In screenshot 4800, logos or other corporate indicia can be added to the logo library by the owner of a logo through use of corporate approval menu 4810. The owner can specify guidelines and timeframe for use of the logo at usage interface 4820 to help ensure brand consistency. The logo can be uploaded to system 5 in various file formats or otherwise provided for addition to the logo library.

In screenshot 4900, a user can manage all of the logos for the tournament through use of management menu 4910. Access to a logo library 4920 can be provided, and a user can drag and drop or otherwise select a logo from the library to be one of the logos available for use in the tournament.

In screenshot 5000, an event activity window 5010 can be provided, which indicates contests and other activities that are taking place during the event. The activity window 5010 can provide contest information as to the location, e.g., the hole, if the prize is provided at the location, if signs have been selected, and if the signs or other supplies have been shipped to the location.

In screenshot 5100, a user is provided with sponsorship information via a summary window 5110. The sponsorship information can include sponsorship levels, costs, logo status, collections and sponsorship goals. In one embodiment, this information is updated in real time or substantially real time as the sponsors join the event through use of system 5. In one embodiment, a user can be provided budget information in comparison with sponsorship or other account receivable information to that the user can easily track the finances of the event. The budget and/or sponsorship or other account receivable information can be updated in real time or substantially real time as the event is being planned, and as sponsors and players are added to the event.

In screenshot 5200, a calendar or time line can be provided for the user for tasks that are current, future, completed or past due, as well as timely reminders for performing the tasks. Details of the tasks can be provided in a details menu 5210. The calendaring of the tasks and reminders can be automated based upon a completion date and/or can provide for customization through an editing menu 5220.

In screenshot 5300, the tournament signs can be created through use of theme menu 5310 and placement menu 5320. The theme menu 5310 allows a user to select from a number of themes or images that will be placed on the signs along with the various logos. The images can be stored in a theme database. In one embodiment, a user can upload or otherwise provide his or her own image for the theme. The placement menu allows a user to add various text to the sign, such as location name and sponsorship information. In another embodiment, the theme, whether selected or customized, can be used to drive system 5 for generating other selections including signage, products, and the like. This single theme selection can be used to generate some or all of an event without the need to customize the entire event. Of course, system 5 allows for such customization, if the user desires it.

In screenshot 5400, system 5 provides for management of merchandising associated with the tournament. A user can use merchandising menu 5410 to select various products for the players, sponsors and/or volunteers. An information window 5420 can provide details of each of the products including the price. In one embodiment, the merchandising menu 5410 allows a user to select various products but delay purchasing of the products. In one embodiment, system 5 provides notice to the user to purchase previously selected products based upon a number of factors, including lead time in obtaining and shipping the products. In screenshot 5500, a user can select and/or purchase products for merchandising based upon a category of the product through use of category window 5510.

In screenshot 5600, a user can provide sponsorship requirements via sponsorship menu 5610. The sponsorship requirements can include the level, cost, number of sponsors at a particular level, number of player spots, and the sponsorship exposure, such as logos on various tournament media.

System 5 can provide interfaces, such as websites, in several formats that can be customized, such as through clicking on and off a website function including weather, banner ads, directions, photos, and so forth. This allows flexibility and familiarity for a user of system 5. In one embodiment, system 5 provides detailed event information to a user. The detailed event information can simplify the award selection process into a few clicks of a mouse.

System 5 can provide a real time look into the events happening at the particular venue. Multiple events can be managed from a single application by a single user. Event Coaches can be provided for assistance to a user, where the Event Coaches have real time details of the event. The system 5 provides for Customer Relationship Management services that allows for an expedited and efficient user experience.

In one embodiment, tournament providers can be provided with the ability to customize a theme to maintain their proprietary brand standards. In one embodiment, the system 5 platform can be integrated directly with its main vendors, including in real time. This can increase efficient flow of communication in both directions, including purchase orders, shipping dates, tracking information, inventory status, and so on.

In another embodiment, the tournament organizer 70 can input products that have already been provided, such as through sponsorship or donation. System 5 can then update the steps of process 300 accordingly.

In one embodiment, system 5 can provide a customized user interface, such as for large management groups who want a uniquely branded look for the underlying application. For example, all events held at a particular golf course could have a representative skin or look and appear to be a service of the golf course but managed by system 5.

In another embodiment, products can be displayed according to those most popular for similar tournaments. This could be sorted by price, popularity, specials of the day or other factors.

In one embodiment, information for tracking a budget, including event spending, can be provided that would allow the functionality of displaying historical spending by category, such as greens fees, apparel, player gifts, snacks, awards, event day activities, and so forth. This historic information can be presented in percentages of the budget. This information can also be used to guide budget setup to know where the industry is on spending by category. These percentages can be selectable by area, state, region and US by the Tournament Operator 70.

In another embodiment, system 5 can provide a complete financial picture of the tournament for audit in one step. The financial information can be pre-formatted for efficient audit and can be certified by an audit firm. In one embodiment, system 5 can provide an invoice to the sponsor for sponsorship payment, and reprinting can also be done.

In one embodiment, system 5 can communicate with participants, sponsors, volunteers and other parties involved in the event through several methods, including e-mails and generation of letters, which can be selected by the Tournament Organizer 70, such as by selecting check boxes. System 5 can also pre-select thank you cards, surveys, receipts and other documents to be automatically generated and sent to various recipients at specified times.

The present disclosure also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

1. An event planning and management system comprising:
a system module for storing event data comprising sponsor information, marketing information, venue information, and current event information;
a sponsor management module using said sponsor information to provide sponsor services;
a marketing management module using said marketing information to provide marketing services;
a venue management module using said venue information to provide venue services;
an event planning module for creating a current event plan using said event data, the event planning module being linked with the sponsor management module, the marketing management module, and the venue management module to provide the sponsor services, the marketing services, and the venue services associated with the current event plan; and
an event management module for managing execution of the current event plan using said current event information and allowing adjustment of the current event plan in real-time, the event management module being linked with the sponsor management module, the marketing management module, and the venue management module to manage and adjust the current event information, the sponsor services, the marketing services, and the venue services associated with the current event plan.

2. The system of claim 1, further comprising a logo management module, wherein the event data further comprises logo information, and wherein the logo management module uses said logo information to provide logo services.

3. The system of claim 2, wherein the event management module is linked with the logo management module to manage and adjust the logo services associated with the current event plan.

4. The system of claim 1, further comprising a participant management module, wherein the event data further comprises participant information, and wherein the participant management module uses the participant information to provide participant services.

5. The system of claim 4, wherein the event management module is linked with the participant management module to manage and adjust the participant services associated with the current event plan.

6. The system of claim 1, further comprising a products management module, wherein the event data further comprises products information, and wherein the products management module uses the products information to provide products services.

7. The system of claim 6, wherein the event management module is linked with the products management module to manage and adjust the products services associated with the current event plan.

8. The system of claim 1, wherein the event data further comprises past event information, and wherein the event planning module further comprises an event cloning module to create the current event plan using the past event information.

9. The system of claim 2, wherein the marketing management module further comprises a signage management module being linked with the sponsor management module, the logo management module, and the venue management module to process at least one of signage creation, signage location, and signage distribution using the event data.

10. The system of claim 1, further comprising a financial management module, wherein the current event information further comprises event schedule information and event financial information, and wherein the financial management module uses said event financial information to provide financial services.

11. The system of claim 10, wherein the event management module is linked with the financial management module to manage and adjust the financial services associated with the current event plan.

12. A computer implemented method of planning and managing an event, the method comprising:
storing event data using a system module, said event data comprising sponsor information, logo information, marketing information, products information, venue information, participant information, current event information, past event information, and financial information;
providing sponsor services based on said sponsor information using a sponsor management module;
providing marketing services based on said marketing information using a marketing management module;
providing venue services based on said venue information using a venue management module;
providing logo services based on said logo information using a logo management module;
providing participant services based on said participant information using a participant management module;
providing products services based on said products information using a products management module; and
providing financial services based on said financial information using a financial management module.

13. The method of claim 12, further comprising:
creating a current event plan based on said event data using an event planning module, the event planning module being linked with the sponsor management module, the marketing management module, and the venue management module to provide the sponsor services, the marketing services, and the venue services associated with the current event plan; and
managing execution of the current event plan based on real-time current event data using an event management module linked with the sponsor management module, the marketing management module, and the venue management module to manage and adjust the current event information, the sponsor services, the marketing services, and the venue services associated with the current event plan.

14. The method of claim 13, wherein the event management module is linked with the logo management module to manage and adjust the logo services associated with the current event plan.

15. The method of claim 13, the event management module is linked with the participant management module to manage and adjust the participant services associated with the current event plan.

16. The method of claim 13, wherein the event management module is linked with the products management module to manage and adjust the products services associated with the current event plan.

17. The method of claim 13, wherein the event planning module further comprises an event cloning module to create the current event plan using the past event information.

18. The method of claim 13, wherein the marketing management module further comprises a signage management module linked with the sponsor management module, the logo management module, and the venue management module to process at least one of signage creation, signage location, and signage distribution using the event data.

19. The method of claim 13, wherein the event management module is linked with the financial management module to manage and adjust the financial services associated with the current event plan.

20. A machine-readable storage having stored thereon, a computer program having a plurality of code sections, said code sections executable by a machine for causing the machine to perform the steps of:
storing event data using a system module, said event data comprising sponsor information, logo information, marketing information, products information, venue information, participant information, current event information, and past event information;
creating a current event plan based on said event data using an event planning module; and
managing execution of a current event plan using an event management module based on the event data being updated in real-time.

21. The machine readable storage of claim 20, further comprising code sections for providing at least one of:
sponsor services based on said sponsor information using a sponsor management module;
marketing services based on said marketing information using a marketing management module; and
venue services based on said venue information using a venue management module, wherein the event planning module is linked with at least one of the sponsor management module, the marketing management module, and the venue management module, and wherein the event management module is linked with at least one of the sponsor management module, the marketing management module, and the venue management module to manage and adjust current event information.

22. The machine readable storage of claim 20, further comprising code sections for:
providing logo services based on said logo information using a logo management module.

23. The machine readable storage of claim 20, further comprising code sections for:
providing participant services based on said participant information using a participant management module.

24. The machine readable storage of claim 20, further comprising code sections for:
providing products based on said products information services using a products management module.

25. The machine readable storage of claim 20, further comprising code sections for:
creating a current event plan using past event information.

26. The machine readable storage of claim 20, further comprising code sections for:
providing financial services based on said financial information using a financial management module.

27. A method of planning and managing an event, the method comprising:
storing event data using a system module, said event data comprising at least one of sponsor information, logo information, marketing information, products information, venue information, participant information, current event information, past event information, and financial information;
providing at least one of sponsor services based on said sponsor information, marketing services based on said marketing information, venue services based on said venue information, logo services based on said logo information, participant services based on said participant information, and products services based on said products information; and
providing financial services based on said financial information using a financial management module in communication with the system module, wherein the financial services are updated in real time.

28. The method of claim 27, wherein a contest occurs during the event, and wherein the financial services comprise processing insurance related to the contest.

29. The method of claim 27, wherein the financial services comprise a comparison of budget information with sponsorship contributions.

30. The method of claim 27, further comprising:
creating a current event plan based on said event data using an event planning module, the event planning module being linked with a sponsor management module that performs the sponsor services, a marketing management module that performs the sponsor services, and the venue management module that performs the venue services; and
managing execution of the current event plan based on the event data updated in real-time using an event management module linked with the sponsor management module, the marketing management module, and the venue management module to manage and adjust the current event information, the sponsor services, the marketing services, and the venue services associated with the current event plan.

31. The method of claim 30, wherein the event planning module further comprises an event cloning module to create the current event plan using the past event information.

32. The method of claim 30, wherein the marketing management module further comprises a signage management module linked with the sponsor management module, the logo management module, and the venue management module to process at least one of signage creation, signage location, and signage distribution using the event data.
